(19) United States
(12) Patent Application Publication
(10) Pub. No.: US 2011/0090487 A1
(43) Pub. Date: Apr. 21, 2011

(54) Methods and apparatus for providing feedback to a subject in connection with performing a task

(76) Inventors: Karl B. Schmidt, Wauwatosa, WI (US); Paul E. Glenn, Wellesley, MA (US); Steven H. Mersch, Germantown, OH (US)

(21) Appl. No.: 11/004,055

(22) Filed: Dec. 3, 2004

Related U.S. Application Data
(63) Continuation of application No. 10/764,984, filed on Jan. 26, 2004, now abandoned.
Application No. 10/764,984 is a continuation of application No. 10/424,588, filed on Apr. 28, 2003, now abandoned.
Application No. 10/424,588 is a continuation of application No. 10/227,635, filed on Aug. 23, 2002, now abandoned.
Application No. 10/227,635 is a continuation of application No. 09/488,601, filed on Jan. 20, 2000, now abandoned.
Application No. 09/488,601 is a continuation-in-part of application No. 09/234,350, filed on Jan. 20, 1999, now abandoned.

(51) Int. Cl. G01B 11/26; H01J 40/14

(52) U.S. Cl. 356/152.1; 250/221; 250/225

(57) ABSTRACT

Methods, apparatus, and systems for providing feedback to a subject in connection with a performance of a task, such as a movement task. The movement task may involve an operation or movement of an object by the subject, such as a body part or a sporting implement. During the movement task, the object has an expected motion path that is associated with one or more target areas. Behavior control feedback may be provided to the subject based on one or more of a position of the object, a motion of the object and an orientation of the object relative to one or more target areas as the subject performs the movement task. One example of an apparatus for providing behavior control feedback includes one or more radiation sources, one or more radiation detectors, and one or more indicators, any of which may be coupled to or otherwise integrated with the object. The object is operated to perform the movement task such that radiation emitted from a source of the apparatus impinges on one or more target areas covered with one or more reflectors. A radiation detector of the apparatus detects radiation that is is reflected from the target areas, and an indicator coupled to the detector provides the behavior control feedback to the subject based on the detected radiation.

### CROSS REFERENCES TO RELATED APPLICATION

The present application claims the benefit under 35 U.S.C. §120 as a continuation (CON) of U.S. Non-provisional application Ser. No. 10/764,984, filed Jan. 26, 2004, which is a continuation (CON) of U.S. Non-provisional application Ser. No. 10/424,588, filed Apr. 28, 2003, which is a continuation (CON) of U.S. Non-provisional application Ser. No. 10/227,635, filed Aug. 23, 2002, which is a continuation (CON) of U.S. Non-provisional application Ser. No. 09/488,601, filed Jan. 20, 2000, which is a continuation-in-part (CIP) of U.S. Non-provisional application Ser. No. 09/234,350, filed Jan. 20, 1999.

Each of these applications is hereby incorporated herein by reference.

### FIELD OF THE INVENTION

The present invention relates to decreasing learning time in a subject, and more particularly, to methods, apparatus, and systems for providing feedback to the subject in connection with performing a task, such as a movement task.

### BACKGROUND OF THE INVENTION

Various methods and apparatus are known for analyzing one or more physical characteristics of a human or animal subject. Such methods and apparatus are employed in medical related applications, for example physical therapy, to facilitate diagnosis and correction of abnormalities associated with posture or motor skills of the subject. For such applications, the subject may be connected to an apparatus capable of measuring one or more physical characteristics of the subject during some procedure, often involving the exertion of some force by or on the subject. For example, the subject may be positioned to stand or otherwise exert some downward force on one or more forceplates which measure the forces exerted by the feet of the subject. By monitoring such forces during the performance of some movement task, a medical professional may obtain information related to the subject's center of gravity and coordination skills, for example.

Similarly, various known methods and apparatus for measuring physical characteristics of the subject may also be used to provide information to the subject itself for training purposes. For example, a variety of training systems have been employed in connection with sports-related applications, in which the subject performs some movement task common to a particular sporting activity, and one or more parameters related to the movement task are measured by the training system. Such training systems may provide the subject with information associated with the subject's performance of the task based on the measured parameters.

The methods, apparatus, and systems described above often may require a number of components and an appreciable amount of space. Moreover, such methods, apparatus and systems often are “invasive” in that they may not allow the subject to perform tasks in a natural setting or in a natural manner. In particular, some training systems may require that the subject divert their attention from performing the task of interest at some point in order to observe and respond to the information provided by the training system.

### SUMMARY OF THE INVENTION

One embodiment of the invention is directed to an apparatus, comprising at least one radiation source to emit radiation, at least one radiation detector to detect the radiation, and at least one indicator coupled to at least one radiation detector to provide behavior control feedback to a subject based on the detected radiation.

Another embodiment of the invention is directed to a method of teaching a subject to perform a movement task involving the subject moving an object. The object has an expected motion path during the movement task, and the expected motion path is associated with at least one target area. The method comprises a step of providing behavior control feedback to the subject based on at least one of a position of the object, a motion of the object, and an orientation of the object relative to at least one target area as the subject performs the movement task, wherein the behavior control feedback indicates a directionality of progress associated with a performance of the movement task.

Another embodiment of the invention is directed to a system, comprising at least one apparatus that includes at least one radiation source to emit radiation, at least one radiation detector to detect the radiation, and at least one indicator coupled to at least one radiation detector to provide behavior control feedback to a subject based on the detected radiation. The system also includes at least one reflector to receive and reflect the radiation emitted from at least one apparatus.

Another embodiment of the invention is directed to an apparatus for use in a system including an object to be operated by a subject to perform a movement task, wherein the object has an expected motion path during the movement task, and the expected motion path is associated with at least one target area. The apparatus of this embodiment comprises at least one radiation source to emit radiation, at least one photoelectric detector to detect the radiation, and at least one processor coupled to at least one photoelectric detector. The at least one processor determines at least one of motion information related to a motion of the object, position information related to a position of the object, and orientation information related to an orientation of the object with respect to at least one target area as the subject performs the movement task, based on the detected radiation. In this embodiment, at least one of a radiation source and a photoelectric detector are coupled to the object.

Another embodiment of the invention is directed to a movement task training apparatus, comprising an implement to be operated by a subject to perform the movement task, and at least one radiation source to emit radiation, wherein the radiation has a predetermined direction of propagation with respect to the implement. The apparatus also includes at least one detector to detect the radiation, and at least one indicator, coupled to the at least one detector, to provide behavior control feedback to a subject based on the detected radiation, as the subject operates the implement to perform the movement task. At least one of a radiation source and a detector is coupled to the implement.

Another embodiment of the invention is directed to a method for indicating a successful golf club swing to a subject as the subject swings a golf club across at least one target area. The method includes a step of providing at least one instantaneous indication to the subject if a club rotation angle of the golf club with respect to the at least one target area is within a predetermined range as the golf club traverses the at least one target area.

### BRIEF DESCRIPTION OF THE DRAWINGS

The drawings are not intended to be drawn to scale. In the drawings, like elements have been given like reference characters.

FIG. 1 is a block diagram of an example of an apparatus according to one embodiment of the invention;

FIG. 2 is a diagram illustrating one exemplary use of the apparatus of FIG. 1 for providing feedback to a subject in connection with swinging a golf club;

FIG. 3 is a close-up view of FIG. 2 at a particular instant during the swing of the golf club;

FIG. 4 is a more detailed block diagram of the apparatus of FIG. 1, according to one embodiment of the invention;

FIG. 5 is a more detailed block diagram of the apparatus of FIG. 1, according to another embodiment of the invention;

FIGS. 6A and 6B are schematic diagrams of an example of a circuit for the apparatus of FIG. 5;

FIG. 7 is a diagram showing an apparatus according to one embodiment of the invention included in a single package attached to the arm of a subject;

FIG. 8 is a diagram showing the single package of FIG. 7 attached to a golf club;

FIG. 9 is a diagram showing the single package of FIG. 7 as a hat worn by a subject;

FIG. 10 is a diagram showing the single package of FIG. 7 as a golf club including components of an apparatus according to various embodiments of the invention;

FIG. 11 is a detailed block diagram of the apparatus of FIG. 1, according to another embodiment of the invention;

FIG. 12 is a block diagram of an example of a subject performance feedback system according to one embodiment of the invention;

FIG. 13 is a block diagram of an example of a subject performance feedback system according to another embodiment of the invention;

FIG. 14 is a diagram of a reflector used in the systems of FIG. 12 or 13, according to one embodiment of the invention;

FIG. 15 is a diagram of a reflector used in the systems of FIG. 12 or 13, according to another embodiment of the invention;

FIG. 16 is a diagram showing the illustration of FIG. 2 including a patterned reflective configuration, according to one embodiment of the invention;

FIG. 17 is a diagram showing another example of a reflector according to one embodiment of the invention;

FIG. 18 is a diagram showing a front perspective three-dimensional view of a golf club being swung across a target area;

FIG. 19 is a diagram showing a top perspective two-dimensional view of the illustration of FIG. 18;

FIG. 20 is a top-perspective view similar to FIG. 19 showing a reflector including differently polarized regions, according to another embodiment of the invention;

FIG. 21 is a top-perspective view similar to FIG. 19 showing a reflector including differently bar coded regions, according to yet another embodiment of the invention;

FIG. 22 is a block diagram of an example of a subject performance feedback system useful for measuring orientation, according to one embodiment of the invention;

FIG. 23 is a top-perspective view similar to FIG. 19 showing a polarizing filter used in the system of FIG. 22;

FIG. 24 is a block diagram of an example of a subject performance feedback system useful for measuring orientation, according to another embodiment of the invention;

FIGS. 25 and 26 are diagrams showing different top-perspective views of a target area of the system of FIG. 24;

FIG. 27A, 27B(1), 27B(2), 28A, 28B, 28C, 28D, 29A(1), 29A(2), 29A(3) are diagrams showing one possible circuit implementation of the system of FIG. 24, according to one embodiment of the invention;

FIG. 30 is a diagram showing a performance feedback system according to another embodiment of the invention utilizing splitting or re-directing elements for the radiation;

FIG. 31 is a diagram showing an example of a performance feedback system according to another embodiment of the invention, in which two apparatus are integrated with the same object to be operated by a subject;

FIG. 32 is a diagram showing a first example of a performance feedback system according to another embodiment of the invention used to measure at least walking or running speed; and

FIG. 33 is a diagram showing a second example of a performance feedback system according to another embodiment of the invention used to measure at least walking or running speed.

### DETAILED DESCRIPTION

The present invention is directed to methods, apparatus, and systems for providing feedback to a subject in connection with performing a task. The subject may be human or animal, and the task may be an activity that can be learned, especially through repetition. In particular, the task may be a movement task and may include the operation or movement of an object attached to or held by the subject. For example, the object may be a body part of the subject that the subject moves to perform a movement task. Alternatively, the object may be a sporting implement or accessory held or worn by the subject, and the movement task may be common to a particular sporting activity. It should be appreciated that the foregoing examples are for purposes of illustration only, and that the invention is not limited to application in connection with movement tasks involving the aforementioned objects.

In various embodiments, the invention provides behavior control feedback that can be interpreted and utilized by the subject to control subsequent behavior, for example, to repeat or modify behavior. In one aspect of the invention, the behavior control feedback indicates a “directionality of progress” associated with the performance of the task; namely, the behavior control feedback provided by the invention alerts the subject of success or failure in performance of the task, and more specifically, may inform the subject that the subject is approaching or moving away from a desired performance goal. For example, the behavior control feedback provided by the invention may indicate performance of a task above or below some threshold criterion or within a particular performance range.

In one embodiment of the invention, behavior control feedback provided to the subject may be essentially instantaneous, thereby allowing the subject to effectively learn and/or verify performance of a task in real time. In another embodiment, the behavior control feedback provided by the invention may be of an aggregate or integrated nature, for example, in the form of one or more parameters derived from one or more instantaneous feedback events. Such aggregate feedback may provide the subject with information pertaining to, for example, success or failure of performance of a task over a number of trials. By interpreting one or both of instantaneous and aggregate behavior control feedback, a subject may reinforce learning and desired performance through successive approximations or iterations of a task.

As discussed above, various known methods, apparatus, and systems for measuring one or more physical characteristics of a subject and for providing information based on the measured characteristics often are complex, require a significant amount of space to implement, and often are invasive, in that they may not allow the subject to perform a task in a natural setting or in a natural manner. Accordingly, Applicants have appreciated that apparatus and systems for providing feedback to a subject in connection with performing a task that are portable, easy to use, and non-invasive (i.e., in that they allow the subject to perform tasks without diverting their attention to obtain the feedback) are desirable and would provide a number of potential advantages with respect to known methods, apparatus, and systems.

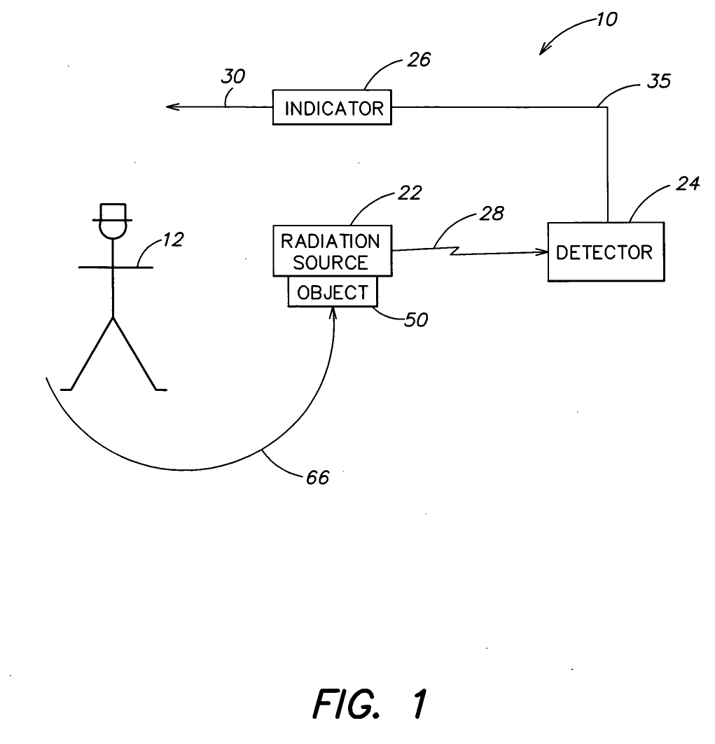

In view of the foregoing, one embodiment of the present invention, as shown in FIG. 1, is directed to a portable lightweight apparatus 10 which conveniently provides behavior control feedback 30 to a subject 12 in a non-invasive manner in connection with performing a task. The apparatus shown in FIG. 1 includes one or more radiation sources 22 to emit radiation 28, one or more radiation detectors 24 to detect the radiation 28 and to output a detected radiation signal 35 based on the detected radiation, and one or more indicators 26 to provide behavior control feedback 30 to the subject 12 based on the detected radiation signal 35.

In FIG. 1, the subject 12 is schematically depicted as performing a movement task 66 by moving or operating an object 50, to which at least one radiation source 22 is coupled. The radiation source 22 and a detector 24 are positioned such that during some point of the movement task 66, it is expected that the radiation 28 impinges upon the radiation detector 24. It should be appreciated that although FIG. 1 shows a radiation source 22 coupled to the object 50, the invention is not limited in this respect. For example, one or more detectors 24 of the apparatus 10 may be coupled to the object 50 instead of the radiation source 22. In this alternate configuration, sources and detectors are positioned such that the radiation 28 emitted by one or more radiation sources 22 located “off-object” impinges on one or more detectors 24 coupled to the object 50 at some point during the execution of the movement task 66.

Additionally, it should be appreciated that according to various other embodiments of the invention as discussed further below, one or both of a radiation source 22 and a detector 24, as well as one or more indicators 26, may be coupled to the object 50. For example, in one embodiment, both one or more radiation sources 22 and one or more detectors 24 are coupled to the object 50. In yet another embodiment, one or more radiation sources 22, one or more detectors 24, and one or more indicators 26 are coupled to the object 50. Furthermore, it should be appreciated that in various embodiments of the invention, any components of the apparatus 10 that are coupled to the object 50 may be, for example, attached to the object via a coupling or attaching device, or alternatively may be “implanted” in the object or otherwise integrated with the object, as discussed further below.

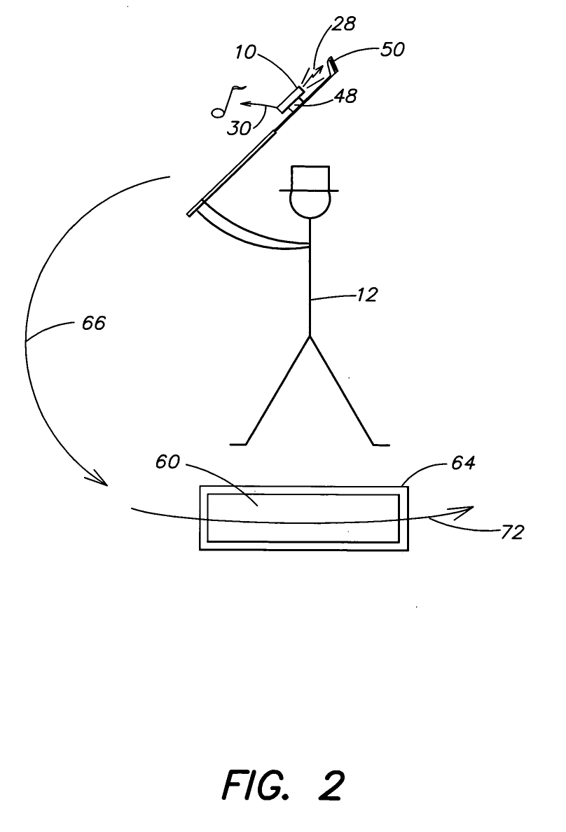

FIG. 2 illustrates one example of how the apparatus 10 of FIG. 1 may be employed to provide behavior control feedback to the subject in connection with performing a movement task. In the example of FIG. 2, the object 50 is shown as a golf club held by the subject, and the movement task 66 involves the subject 12 swinging the golf club. In the example of FIG. 2, the apparatus 10 facilitates the subject's learning and desired performance in connection with successfully swinging the golf club.

In FIG. 2, the apparatus 10 is shown for purposes of simplicity as a “single package” that includes at least one of each of a radiation source, a radiation detector, and an indicator. The apparatus is coupled to the golf club via an attachment 48, such that the radiation 28 emitted by the radiation source propagates toward a head of the golf club in a direction that is essentially parallel to a shaft of the golf club. In this manner, the radiation 28 simulates an axis of the golf club as the golf club is swung. The subject swings the golf club along a swing path 72 that includes at least one target area 64. As part of a performance feedback system according to one embodiment of the invention (discussed further below), one or more reflectors 60 are placed in the target area 64. As the subject swings the golf club through the swing path 72, the radiation 28 emitted from the apparatus 10 impinges on the reflector 60 in the target area 64.

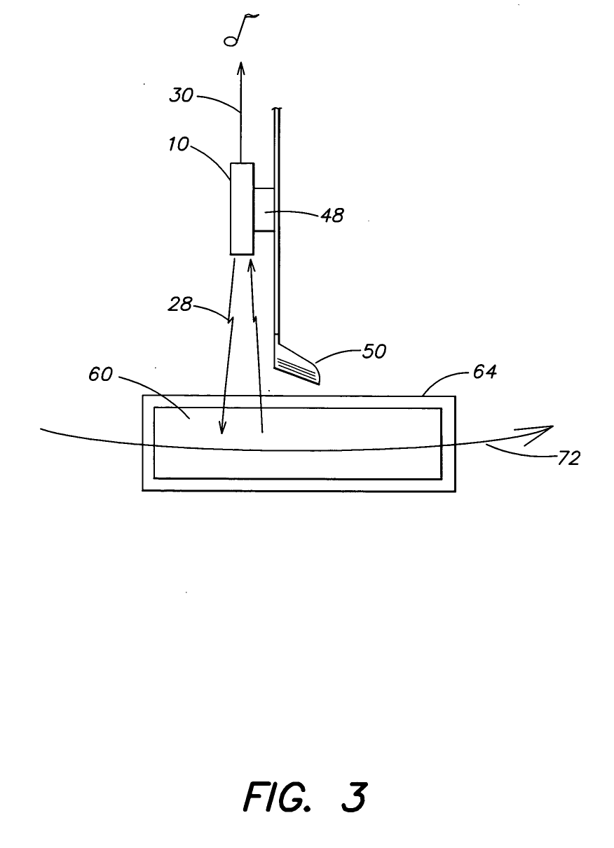

FIG. 3 shows a portion of the illustration of FIG. 2 during the movement task 66, or swing, as the golf club traverses the target area 64 such that the radiation 28 impinges on the reflector 60. The reflector 60 provides one or more reflections of the radiation 28 as the golf club traverses the target area. The radiation detector of the apparatus 10 detects the one or more reflections, and the indicator of the apparatus 10 provides an indication (e.g., an audible or visible indication) to the subject when the detector detects the one or more reflections. In this manner, the indicator provides the subject with behavior control feedback 30 indicating the success or failure of the subject in swinging the golf club through the target area.

In the exemplary application of FIG. 2, it should be appreciated that if the subject does not successfully swing the golf club across the target area, the subject nonetheless receives behavior control feedback from the apparatus 10 in the form of the absence of an indication; such an “absent indication” provides the subject with feedback indicating failure in executing the movement task as desired.

Additionally, although the apparatus 10 is shown in both FIGS. 2 and 3 as being coupled to the golf club on the shaft of the club proximate to the head of the club, it should be appreciated that any or all of the components included in the apparatus 10 may be coupled to the golf club in numerous ways and in a variety of locations (e.g., below a hand grip of the club, on the head of the club, anywhere along the shaft of the club, implanted within the club). Furthermore, while the example application shown in FIGS. 2 and 3 depict the subject swinging a golf club, it should be appreciated that the apparatus 10 may be used in conjunction with a variety of other sporting implements (e.g., tennis rackets, baseball bats), body parts of the subject (e.g., legs, arms, feet, hands), and/or other objects operated or moved by the subject to provide behavior control feedback to the subject in a manner similar to that described above in connection with FIGS. 2 and 3.

Following below are more detailed descriptions of various concepts related to, and embodiments of, methods, apparatus, and systems according to the present invention for providing feedback to a subject in connection with performing a task. It should be appreciated that various aspects of the invention as discussed above and outlined further below may be implemented in any of numerous ways, as the invention is not limited to any particular manner of implementation. Examples of specific implementations are provided for illustrative purposes only.

With respect to providing feedback to a subject, Applicants have recognized that learning and repetition of a desired performance are best facilitated when one or more instructive stimuli occur instantaneously. Accordingly, Applicants have appreciated that to optimize learning and repetition of a desired performance, behavior control feedback ideally occurs during the execution or performance of a particular behavior. However, Applicants also appreciate that behavior control feedback may be useful at any time to facilitate behavior development toward a performance goal. Hence, for purposes of the present disclosure, behavior control feedback refers generally to any information-bearing stimulus or stimuli that can be acknowledged and utilized by a subject, for example, to further learning, modify or optimize performance, or repeat a desired performance. More specifically, behavior control feedback refers to one or more indications of a directionality of progress associated with the subject's learning and/or performance of a particular behavior. The behavior control feedback may be one or more indications of “success” or “failure”; in any case, the feedback can be interpreted and used by the subject, for example, to repeat or modify subsequent behavior.

One aspect of the present invention is the ability to provide instantaneous behavior control feedback. The instantaneous nature of the feedback is limited only by the reaction time of a particular subject to a particular stimulus. For example, the human system of nerves of muscles has an approximate reaction time of fractions of seconds. Average reaction times amongst different species of animals can vary dramatically. In general, reaction time depends not only a particular stimulus, be it aural, visual, olfactory, or tactile, but several other factors as well, such as, for example, ambient conditions and the state of alertness of the subject.

While instantaneous behavior control feedback is ideally provided to a subject during a task, it is indeed possible for some subjects to complete tasks, in particular some movement tasks, in a time shorter than their reaction time. This could be especially true of high velocity movement tasks, such as, for example, swinging a bat, racket, golf club, and the like. In various embodiments, methods and apparatus of the present invention are nonetheless effective in facilitating learning and repetition of a desired performance of both low and high velocity tasks if the instantaneous behavior control feedback is provided within a time as close as possible to the execution of the task, limited only by the reaction time of the subject.

Instantaneous behavior control feedback therefore refers to one or more instructional stimuli that occur quickly enough so that interpretation of the stimuli by the subject is more of an instinctive reflex, or involuntary process, rather than a conscious or voluntary process, for the latter case would draw the subject's attention away from the desired task. In this manner, various embodiments of the invention may facilitate learning and optimization of task performance on a subconscious level by providing instantaneous behavior control feedback in a convenient, non-invasive manner that does not necessarily distract the subject's attention from the task at hand. Accordingly, for purposes of the present disclosure, the term instantaneous is defined preferably as a time before which a subject's attention is consciously diverted from a desired task, more preferably within fractions of seconds of the completion of a task, even more preferably within 0.2 seconds of the completion of a movement task, even more preferably within 0.1 second of the completion of a task, and even more preferably during the execution of a task.

As discussed above, methods, apparatus, and systems according to various embodiments of the invention may also facilitate learning and repetition of a desired performance by providing instructional feedback of an aggregate or integrated nature. For example, instantaneous feedback obtained from a number of execution trials of a task may be utilized to provide several forms of aggregate feedback. Furthermore, since the instantaneous feedback itself may include one or more feedback events, or indications of progress, information pertaining to an aggregate quality of a number of individual feedback events during a single execution of a task may be provided as aggregate feedback by the invention.

For example, with reference to the example of a performance feedback system shown in FIGS. 2 and 3, if the behavior control feedback in a given performance situation includes a series of audible indications resulting from radiation being reflected from a number of different target areas along or proximate to an expected motion path throughout the execution of a single movement task, one possible form of aggregate or integrated feedback can include distance or position information of an object along a portion of the motion path relative to a particular target area. Likewise, velocity of motion may be determined from such a collection of discrete indications and reported to the subject as aggregate behavior control feedback.

Accordingly, it should be appreciated that examples of aggregate feedback include, but are not limited to, information pertaining to a number of execution trials, such as elapsed time, or time between trials, and any parameter derived therefrom, such as average speed or velocity of execution, average time to complete a trial, and the like. Aggregate feedback may also include any information derived from individual feedback events, indications, or patterns of indications constituting an instantaneous behavior control feedback from a single execution of a task. In particular, in various embodiments of the invention, aggregate behavior control feedback may be provided based on known time and spatial relationships between one or more feedback events (e.g., radiation detection events) or indications that may also provide instantaneous feedback. From the foregoing, it should be appreciated that a wide variety of instantaneous and/or aggregate behavior control feedback may be provided by methods, apparatus, and systems according to various embodiments of the invention in connection with the performance of a task.

For example, in embodiments of the invention in which a subject operates or moves an object to perform a movement task, wherein the object has an expected motion path that is associated with one or more target areas, instantaneous and/or aggregate behavior control feedback provided by the invention may include, be based on, or be derived from, a variety of position information related to a position of the object as the object traverses one or more target areas, motion information related to a motion of the object as the object traverses one or more target areas, and orientation information related to an orientation of the object as the object traverses one or more target areas. In particular, in one embodiment, a system according to the present invention is capable of measuring various position, motion and/or orientation information of an object operated by a subject to perform a movement task, and such information is processed so as to provide behavior control feedback to the subject based on the position, motion and/or orientation information.

Examples of position information related to the object include, but are not limited to, a vertical distance of the object above one or more target areas, or a distance of the object from a particular target area in the plane of the target area.

Examples of motion information related to the object include, but are not limited to, a velocity of the object as the object traverses one or more target areas, an acceleration of the object as the object traverses one or more target areas, a motion path angle of the object as the object traverses one or more target areas, and an approach angle, or “angle of attack,” of the object as the object traverses one or more target areas.

Examples of orientation information related to the object include, but are not limited to, a rotation of the object about one or more of three perpendicular axes of rotation in a coordinate space relative to one or more target areas as the object traverses a target area, and a rotation of the object about its own axis of rotation relative to the coordinate space of one or more target areas. In particular, as in nautical and aeronautical applications, orientation information may include one or more of a yaw angle, a roll angle, and a pitch angle of the object relative to the coordinate space of a particular target area as the object traverses the target area.

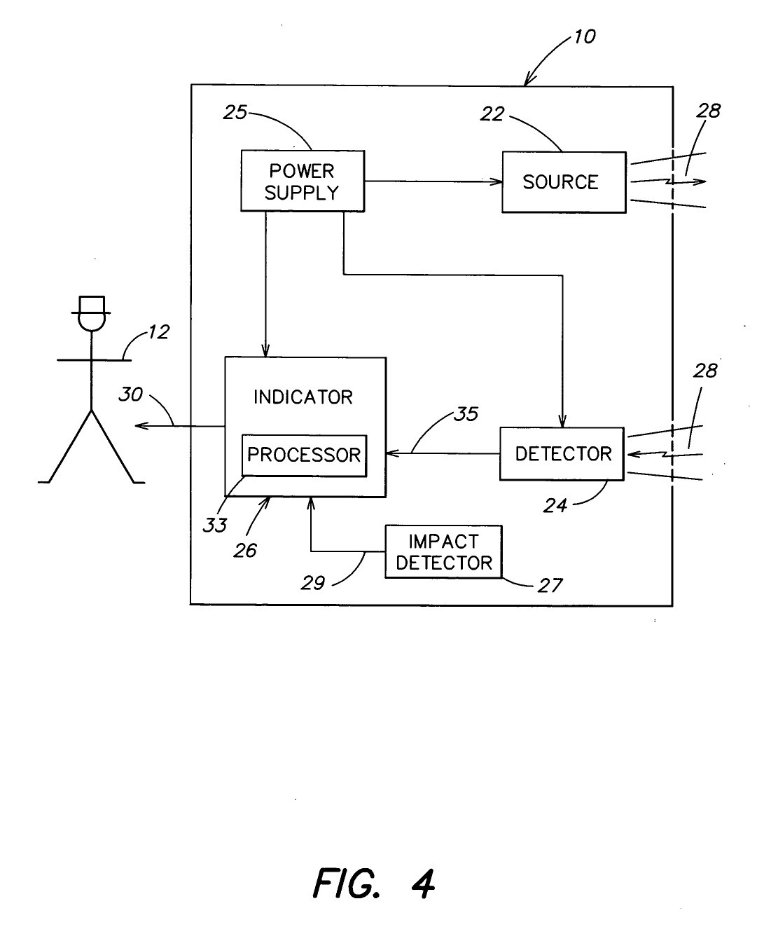

FIG. 4 shows a more detailed block diagram of an example of the apparatus 10 according to one embodiment of the invention. As in FIG. 1, the apparatus 10 of FIG. 4 includes one or more radiation sources 22 to emit radiation 28. Examples of sources suitable for purposes of the apparatus of FIG. 4 include, but are not limited to, light emitting diodes (LEDs) and lasers having various wavelengths. In one aspect of this embodiment, the radiation source 22 may include a diode laser and a collimator lens (not shown in FIG. 4), and output red radiation having a wavelength of approximately 650 nm, in a manner similar to that of a conventional laser pointer. It should be appreciated, however, that the foregoing example is provided for purposes of illustration only, and that lasers and other radiation sources having different wavelengths may be suitable for various other embodiments of the invention.

The apparatus 10 shown in FIG. 4 also includes one or more detectors 24 to detect the radiation 28 emitted from the source 22 and to output a detected radiation signal 35 based on the detected radiation. In one aspect of this embodiment, the detector may include one or more photoelectric-type detectors, and additionally may be a high-speed detector, which may be particularly advantageous for providing performance feedback in applications involving high velocity movement tasks. However, it should be appreciated that various types of detectors are suitable for purposes of the invention, and the appropriate parameters of the detector, such as, for example, shape, size, material, sensitivity, and response time depend at least in part on the type of radiation source used. Additionally, it should be appreciated that the detector 24 is not necessarily limited to photoelectric-type detectors, and that other sensing devices which are responsive to a variety of radiation wavelengths may be employed in various embodiments of the invention.

In one aspect of the embodiment of FIG. 4, one or more detectors 24 may be “co-located” with one or more sources 22 of the apparatus 10. For purposes of the present disclosure, the term co-located is defined generally as positioned such that radiation from a source cannot directly impinge on a detector without at least one intervening reflection. This definition implies that an output face of a source and a receiving face of a detector do not directly oppose each other. Stated differently, co-located refers to a source and detector that are placed together, without facing each other. The source and detector may be placed together, for example, on the same object or within the same object, and may be either some distance apart on or in the object, or proximate to each other. One example of a co-located source and detector includes a source and a detector that are placed side-by-side, such that the radiation emitted by the source is essentially parallel to the radiation received by the detector, as illustrated in FIG. 4.

The apparatus 10 of FIG. 4 also includes one or more indicators 26 to provide behavior control feedback 30 to a subject 12 based on one or more detected radiation signals 35, as discussed above in connection with FIG. 1. Examples of indicators suitable for purposes of the invention include, but are not limited to, those which provide the behavior control feedback in the form of one or more audible indications, including voice message indications, visible indications, tactile indications, such as, for example, vibrational indications, or combinations of the above. Such indicators can be in the form of transducers such as piezoelectric devices, buzzers, audio speakers, voice chips, various illuminating devices such as incandescent lamps or LEDs, video graphics display monitors, and the like. The behavior control feedback may include, for example, a continuous indication for a prescribed time, an indication for as long as the detector detects the radiation, or any of several sensory patterns of indication. It should be appreciated that, based on a number of different indicators that are suitable for purposes of the invention, the behavior control feedback 30 may include a wide variety of feedback types, from a simple audible indication to a complex graphical display, for example.

FIG. 4 also shows that one or more indicators 26 of the apparatus 10 may include one or more processors 33 which determine various information from one or more detected radiation signals 35. The processor 33 may perform any number of functions based on one or more detected radiation signals 35 to control the indicator 26 so as to provide the behavior control feedback 30, which, as described above, may be instantaneous and/or aggregate in nature, and may be in the form of one or more various sensory indications. The processor may include, for example, a simple circuit to drive a buzzer, audio speaker, lamp or LED, and/or may include a CPU along with volatile and/or permanent (e.g., EPROM) memory storage to process one or more detected radiation signals and determine a variety of potentially complex position, motion, and orientation information from detected radiation signals. The processor 33 may control the indicator 26 so as to provide, for example, sophisticated audible indications and/or video images and graphics. In general, the processor 33 may be either a hardware oriented controller and/or may include one or more computers that execute one or more programs (e.g., software, micro code) to perform various functions in connection with obtaining information from the detected radiation signals 35 and controlling the indicator 26 to provide the behavior control feedback 30.

FIG. 4 also shows that, according to one embodiment, the apparatus 10 may include one or more impact detectors 27, in addition to one or more radiation detectors 24, to detect a pressure disturbance in a vicinity of the apparatus 10. In one aspect, the impact detector 27 may be, for example, a piezoelectric sensor which acts as a shock sensor to output a detected disturbance signal 29 to the indicator 26 (or, more particularly, to the processor 33 of the indicator 26). In this manner, the processor 33 may determine impact information based on the detected disturbance signal 29. Additionally, FIG. 4 shows that the apparatus 10 includes one or more power supplies 25 to provide power to at least the source 22, the detector 24, and the indicator 26. Examples of power supplies suitable for purposes of the invention include, but are not limited to, various types of batteries or solar cells.

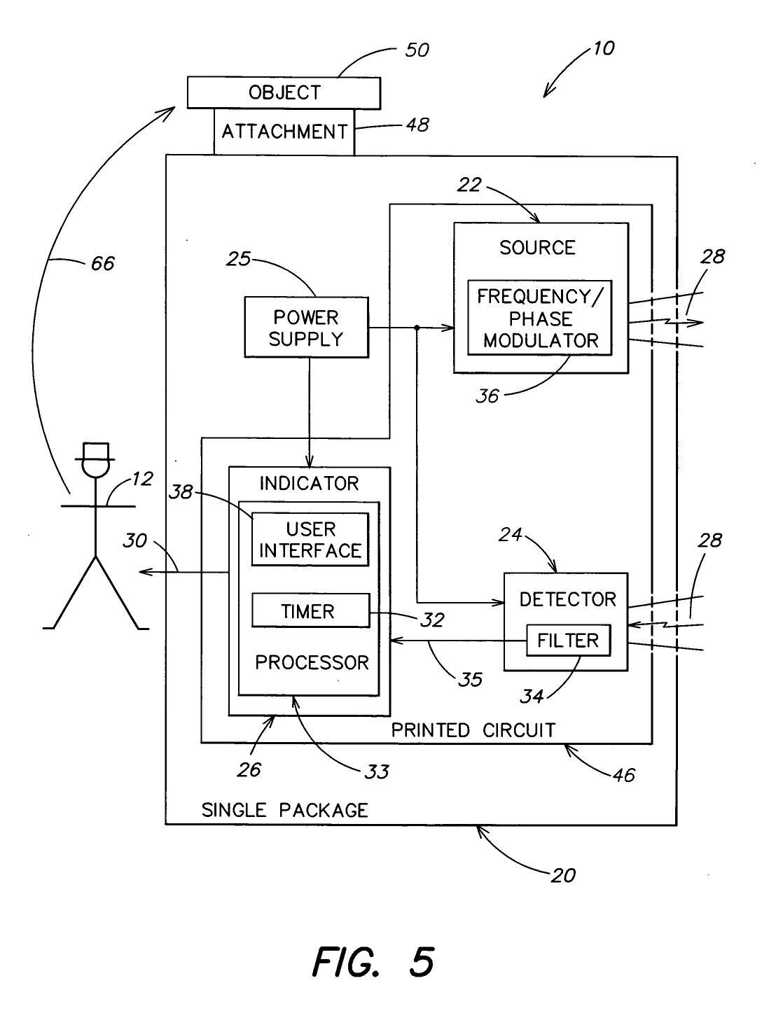

FIG. 5 shows a detailed block diagram of the apparatus 10 of FIG. 1, according to another embodiment of the invention. In the embodiment of FIG. 5, the apparatus utilizes encoded radiation so that the apparatus is operable in a variety of ambient conditions. For example, by appropriately encoding the radiation 28, the apparatus avoids interference from ambient lighting conditions. In particular, the apparatus may be used outdoors without being operationally affected by sunlight. As shown in FIG. 5, one example of an apparatus utilizing encoded radiation includes a laser for the source 22, wherein the source includes a frequency and/or phase modulator 36 to provide the encoded radiation 28. For example, in one aspect of this embodiment the radiation 28 may be encoded with a constant frequency carried by the radiation.

In the apparatus of FIG. 5, the detector 24 includes one or more filters 34 to detect only encoded radiation, so that ambient conditions such as lighting do not adversely affect the operation of the apparatus. In particular, the filter 34 passes only encoded radiation, and in various aspects of this embodiment may be either optically or electrically coupled to the detector 24. The indicator 26 provides the behavior control feedback 30 based on detected encoded radiation. One or more sources 22 of FIG. 5 may also emit polarized radiation, for example linearly or circularly polarized radiation, which may be useful for a number of applications, some of which are discussed further below.

In the embodiment of FIG. 5, the processor 33 includes a timer 32 to provide the behavior control feedback for at least a minimum perceivable time, even if the detector detects the radiation for less than the minimum perceivable time. For purposes of the invention, minimum perceivable time refers to a minimum time required for a particular subject to acknowledge a particular indication, or a reaction time, as discussed earlier. For example, human and animal subjects have varying reaction times as well as varying degrees of minimum resolution in connection with aural, visual and tactile acuity. Typically, humans can hear sounds in a frequency range of approximately 20-15,000 Hz, but cannot distinguish audible sounds that are shorter than approximately 10 milliseconds in duration. Likewise, humans typically require approximately 1 millisecond to acknowledge the presence of an object in their field of vision, and cannot distinguish frequencies of blinking lights higher than approximately 50 blinks per second, depending on the brightness and size of the lights. Of course, the above discussion is for purposes of illustration only, and actual reaction times and sensory acuity depend not only on the subject, but on ambient conditions as well. The timer 32 of FIG. 5, however, allows the indicator to provide recognizable behavior control feedback to the subject even if the detector detects radiation for a time less than some biological threshold represented by a minimum perceivable time.

FIG. 5 also shows that the processor 33 may additionally include a user interface 38 to perform a variety of functions. For example, if the behavior control feedback includes one or more audible indications, the user interface can be used to select a frequency of a particular audible indication. For one or more visible indications, likewise the user interface can be used to select a display mode of the visible indication, such as color, blinking frequency, various graphics displays on a monitor, or combinations of the above. In general, the user interface 38 allows the subject 12 to interact with the apparatus 10 and select modes of operation, ranges and thresholds for various performance parameters measured by or derived from one or more detected radiation signals 35, modes of behavior control feedback indication based on measured or derived parameters, and the like, as discussed further below. The user interface 38 may be in the form of one or more keypads, keyboards, buttons, switches, joysticks, is potentiometers, and the like, for example, or any combination of the foregoing examples.

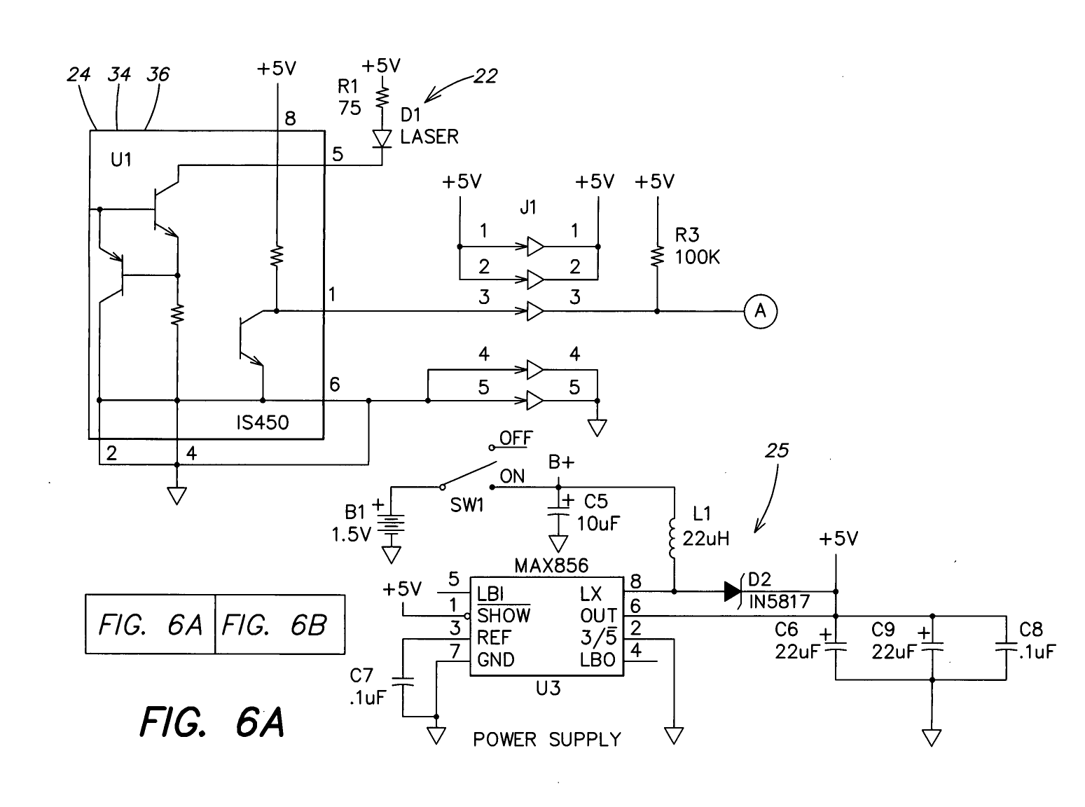

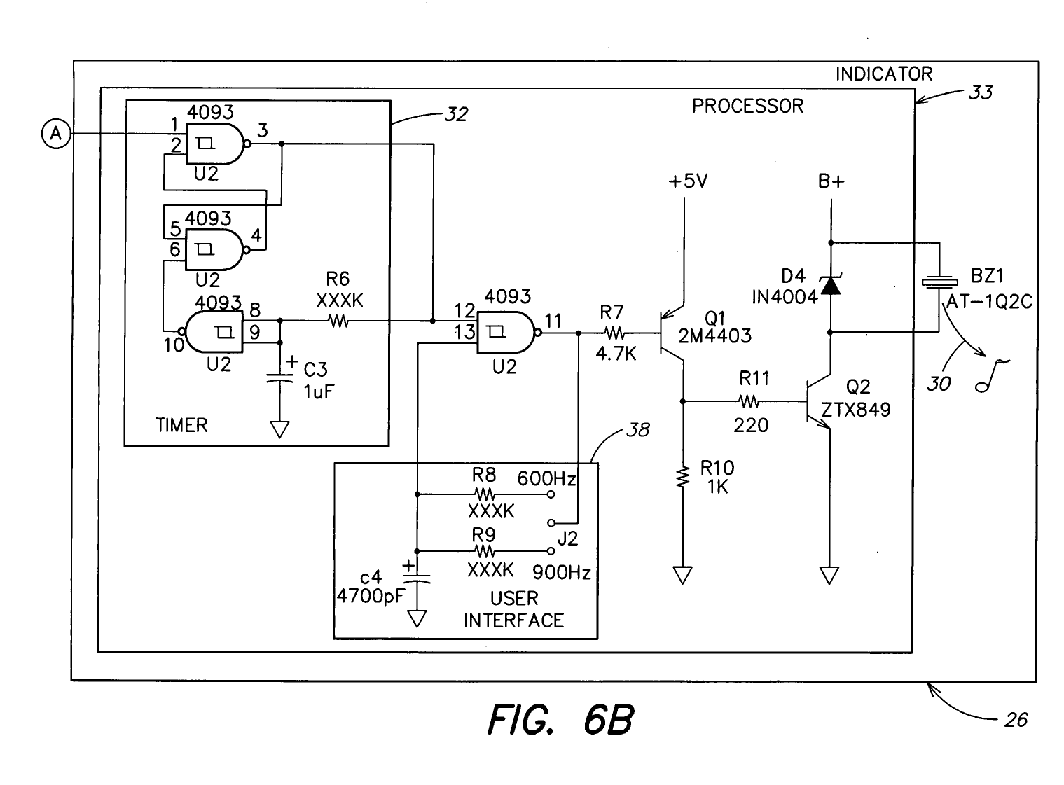

FIG. 6 shows a schematic diagram of an example of a circuit for the apparatus of FIG. 5. The source 22 of FIG. 6 is shown as a diode laser D1. Integrated circuit chip U1 includes a photodetector, a frequency and phase modulator, and a filter for the detector. The devices integrated in chip U1 correspond to elements 24, 36 and 34, respectively, of FIG. 5. An example of an integrated circuit chip suitable for the circuit of FIG. 6 includes an OPIC-IS450 Light Detector with Built-in Signal Processing Circuit for Light Modulation, manufactured by Sharp Electronics. The output of chip U1, indicated in the schematic at terminal 1, is connected to timer 32, which includes three Schmitt trigger NAND gates U2, capacitor C3 and resistor R6. The output of the timer 32 is further processed by circuitry within processor 33 to provide behavior control feedback 30, illustrated as an audible tone provided by a buzzer BZ1 in indicator 26. The processor 33 further includes a user interface 38 including resistors R8 and R9, capacitor C4, and jumper J2, to select a frequency of buzzer BZ1. FIG. 6 further shows a circuit for power supply 25, including battery B1, for supplying power to the various circuit components.

In one aspect of the embodiments of the apparatus 10 shown in FIGS. 1, 4 and 5, the apparatus 10, including at least one source 22, at least one detector 24, at least one indicator 26, and the power supply 25, are located within a single package. In yet another aspect, the source, detector, and indicator may additionally be located together on a single printed circuit 46. In particular, FIG. 5 shows that the single package 20 may include an attachment 48 to attach the single package to the object 50 operated by the subject 12 to perform the movement task 66. Examples of attachments suitable for purposes of the invention include, but are not limited to, mechanical attachments such as clamps, clasps, straps, buckles, synthetic material or textile strips forming hooks or loops, suction devices, glues and adhesives, or magnetic devices.

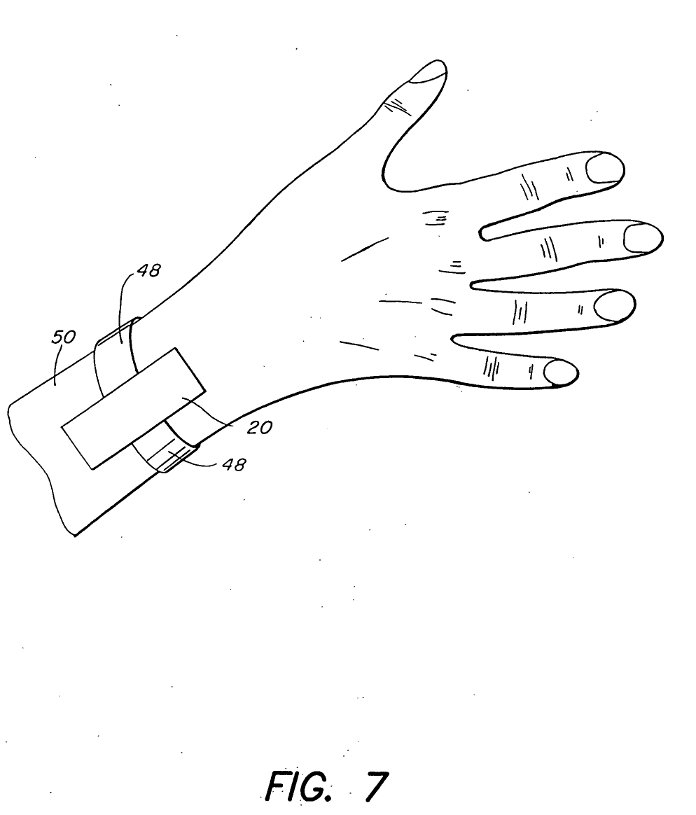

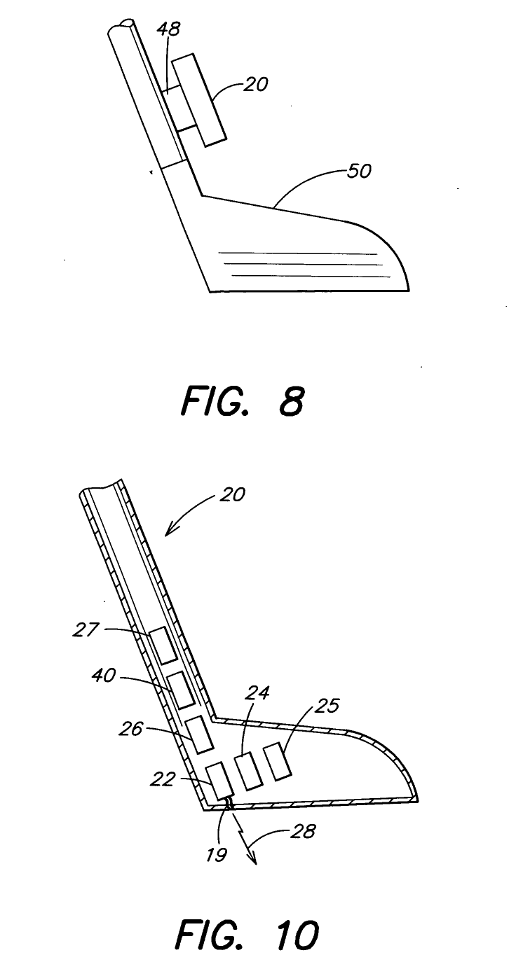

As discussed above, the object 50 to which the single package is attached can be a body part of the subject, as shown in FIG. 7, or an implement that can be attached to or held by the subject, as shown in FIG. 8. Examples of implements include, but are not limited to, sporting implements such as golf clubs, rackets, and bats. FIG. 8 shows an example of the single package 20 attached to a golf club 50 by attachment 48. While FIGS. 7 and 8 show the single package 20 attached externally to an object 50, the object 50 may be configured such that the single package 20 may be attached on an inner surface of the object 50, or otherwise attached within the physical structure of the object 50, as discussed further below.

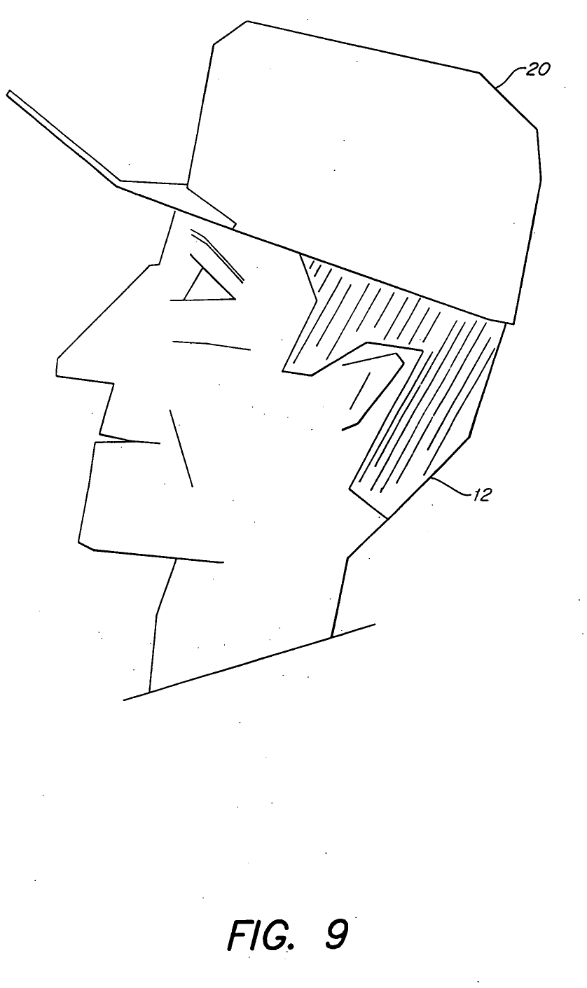

The single package 20 may also be an accessory worn by the subject. FIG. 9 shows an example of the single package as a hat 20 worn by the subject 12. Other examples of single package accessories include, but are not limited to, garments such as shoes and gloves, including sportswear such as helmets and skates.

Likewise, the single package 20 itself may be a sporting implement or other object operated by the subject. FIG. 10 shows one possible example of a golf club serving as a single package 20 for the apparatus of the invention. The golf club 20 shown in FIG. 10 may be considered as an “intelligent” sporting implement, in that one or more components of apparatus according to various embodiments of the invention are contained inside the sporting implement. In particular, as shown in FIG. 10, at least one source 22, at least one detector 24, at least one indicator 26, an impact detector 27, and power supply 25 may be co-located within the physical structure of the golf club 20. The golf club 20 may also include one or more fiber optic cables 19 to transport the radiation 28 emitted by one or more sources 22.

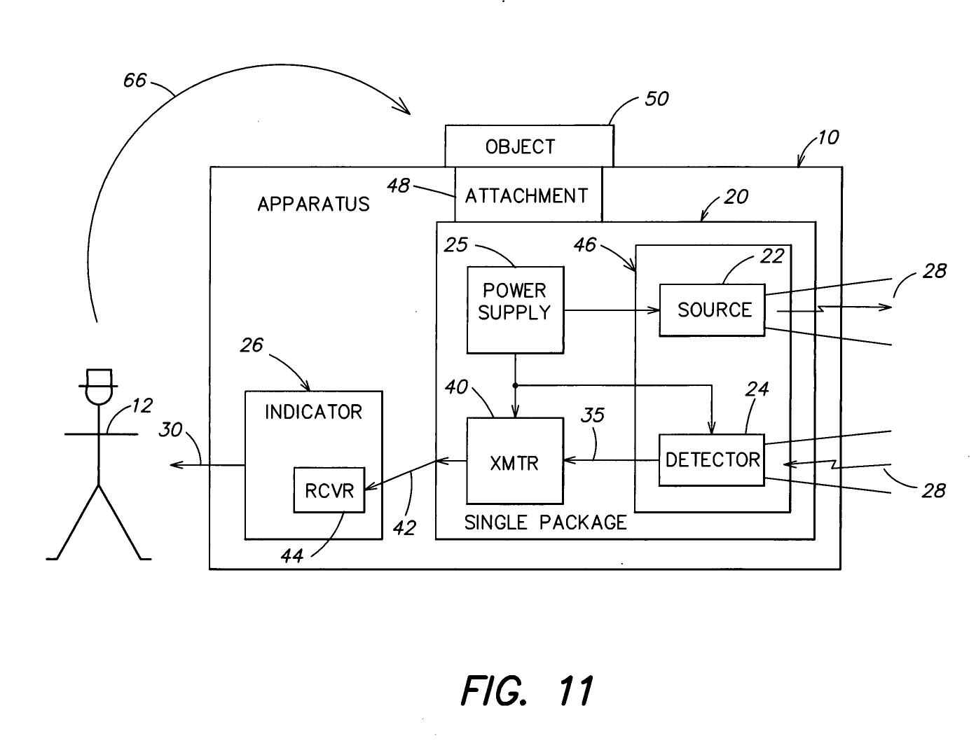

While FIGS. 5 and 7-10 show various components of an apparatus according to one embodiment of the invention as a single package, as discussed above it should be appreciated that all of the components of an apparatus need not be packaged together, embedded within an “intelligent implement,” or coupled together to a same object. For example, FIG. 11 shows another embodiment of the example apparatus 10 of FIG. 1, in which at least one source 22, at least one detector 24 and at least one power supply 25 are located within the single package 20, while one or more indicators 26 are located remotely from the single package. The source and detector may additionally be located together on a single printed circuit board 46 within the single package 20. In this embodiment, the single package further includes a transmitter 40 to transmit a transmit signal 42 corresponding to the detected radiation signal 35 provided by the detector 24 based on the detected radiation, and the indicator includes a receiver 44 to receive the transmit signal 42. Several known methods and apparatus for signal transmission and reception may be used with the invention as appropriate for a given application. Some examples of such methods and apparatus include, but are not limited to, radio or microwave (wireless) transceivers, optical communications, telephony, and the like. In is one implementation of FIG. 11, the transmitter 40 and the receiver 44 may be simple amplifiers, and the transmit signal 42 may be carried by a wire conductor to a remote indicator 26.

As in the previous embodiment, the single package 20 of FIG. 11 may include an attachment 48 to attach the single package to an object 50 operated by the subject 12. As shown in FIGS. 7 and 8 and as discussed above, the object 50 can be a body part of the subject or an implement capable of being attached to or held by the subject, such as a sporting implement. Alternatively, the single package may be an accessory worn by the subject, as shown, for example, in FIG. 9, or an “intelligent” sporting implement, as shown in FIG. 10. To implement the embodiment of FIG. 11 in the intelligent sporting implement of FIG. 10, the indicator 26 (shown in FIG. 10 as embedded within the golf club) would be replaced by transmitter 40.

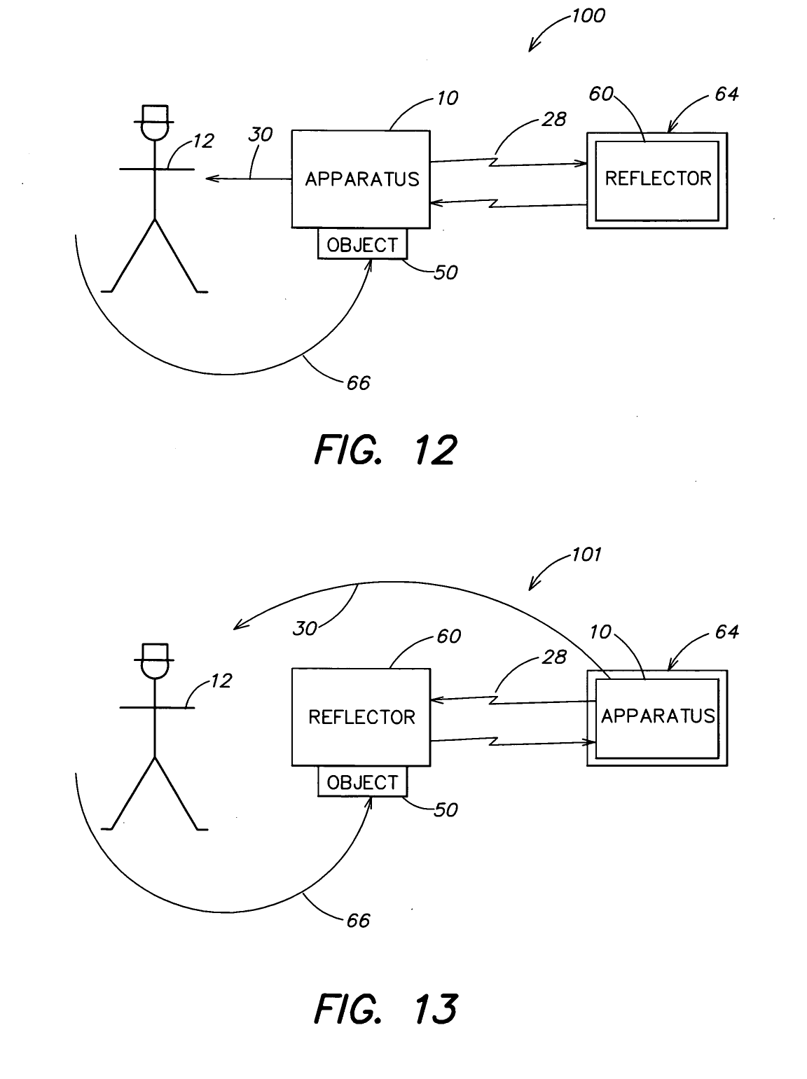

FIG. 12 is a diagram illustrating an example of a performance feedback system 100 according to one embodiment of the invention, for providing feedback to the subject 12 in connection with the movement task 66. The system of FIG. 12 may be utilized, for example, to provide feedback to a subject in connection with swinging or otherwise operating a sporting implement, such as a golf club, as shown in FIGS. 2 and 3. It should be appreciated, however, that the system 100 shown in FIG. 12 is not limited in this respect, as the system has a wide range of applicability in other movement tasks, involving other types of sporting implements or movement of one or more of a subject's body parts during a movement task, for example.

The example of the system 100 shown in FIG. 12 includes at least one apparatus 10 according to various embodiments of the invention. In particular, the apparatus 10 illustrated in FIG. 12 includes at least one source to emit radiation 28, at least one detector to detect the radiation, and at least one indicator to provide behavior control feedback 30 to the subject 12 based on the detected radiation. The apparatus 10 may be implemented, for example, as discrete components, as a signal package as shown in FIGS. 5 and 7-10, or as a signal package including a source and a detector, used in conjunction with a remote indicator, as shown in FIG. 11. The performance feedback system 100 further includes at least one reflector 60 to receive the radiation 28 from one or more apparatus 10, and to reflect the radiation. Although a system similar to that shown in FIG. 12 was briefly described above in connection with FIGS. 2 and 3 (illustrating a golf club swing), the system of FIG. 12 functions more generally as follows.

In the system of FIG. 12, one or more target areas 64 are covered with one or more reflectors 60. In some sense, the reflectors in the system of FIG. 12 may be considered as essentially “defining” the target areas. One or more target areas 64 generally are chosen proximate to or within an expected motion path of the object as the subject operates the object to perform the movement task. Additionally (or alternatively), one or more target areas 64 having some known spatial relationship to the motion path or other target areas may be chosen. The location, shape, size and type of target areas, or the number of target areas, are unlimited for purposes of the invention, and may be dictated by the particular application for which the system 100 is employed. In one aspect, a given target area may be limited only by the dimensions of the one or more reflectors 60 used to cover it.

In the example system of FIG. 12, a radiation source of the apparatus 10 is integrated with the object 50 operated by the subject 12 to perform the movement task 66. The subject attempts to move the object 50 through the expected motion path such that the radiation 28 impinges on one or more reflectors 60 within one or more target areas and is reflected therefrom. A detector of the apparatus 10, which optionally may be co-located with the source and coupled to the object 50, detects the reflected radiation as the object traverses one or more target areas, and an indicator of the apparatus 10 provides behavior control feedback 30 to the subject 12 based on the detected radiation. As discussed above, the indicator may be integrated with the object, or may be located remotely from the source and the detector. The behavior control feedback may be provided essentially instantaneously, for example, by indicating when the detector detects the reflected radiation, and/or may be provided as an aggregate feedback.

While the example system of FIG. 12 shows that at least some components of the apparatus 10 are integrated with or coupled to the object 50, FIG. 13 illustrates an example of a system 101 according to another embodiment of the invention having an alternative arrangement of elements, in which one or more reflectors 60 are integrated with or coupled to the object 50. The example of the movement task feedback system shown in FIG. 13 functions as follows.

In the system of FIG. 13, one or more apparatus 10 are arranged such that radiation 28 emitted from a source of each apparatus is directed through a particular target area 64. As discussed above, the target area may constitute a portion of an expected motion path of the object as the subject operates the object to perform the movement task, or may be proximate to the expected motion path and/or in some known spatial relationship with respect to one or more other target areas or the motion path. In the system of FIG. 13, each apparatus 10 may be considered as essentially “defining” a respective target area. One or more reflectors 60 are integrated with the object 50 such that the radiation 28 from one or more apparatus 10 impinges on the one or more reflectors 60 during the movement task. One or more detectors of each apparatus 10 detect the radiation reflected from the object, and one or more indicators provide behavior control feedback 30 to the subject 12 based on the detected radiation. As in the example system of FIG. 12, the behavior control feedback may be provided essentially instantaneously, for example, by indicating when the detector detects the reflected radiation, and/or may be provided as an aggregate feedback.

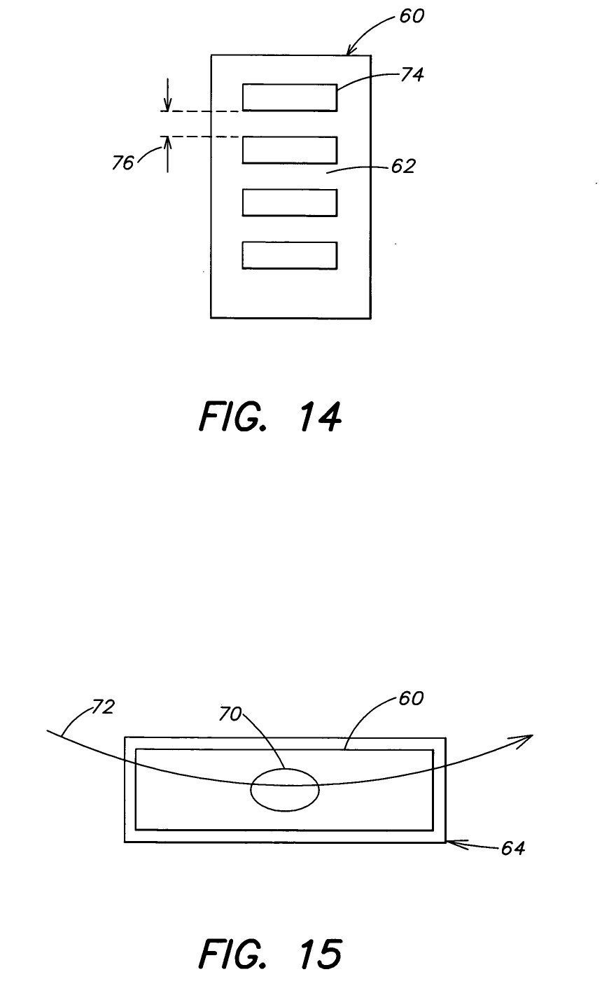

FIG. 14 shows that one or more reflectors 60 of the performance feedback systems 100 and 101 shown in FIGS. 12 and 13 may include a patterned reflective configuration 62. Such configurations 62 may include, but are not limited to, patterns of discrete reflective strips or patches, bar codes, a continuous piece of reflective material shaped or fashioned in a particular manner, or combinations of the above. Moreover, a given reflector 60 may also be a retro-reflector, and the patterned reflective configuration 62 may include a patterned retro-reflective configuration. A retro-reflector has the characteristic of reflecting radiation back in a direction of propagation opposite to that of the radiation incident to the retro-reflector. FIG. 14 shows one example of a patterned reflective configuration 62 including individual rectangular patches 74 spaced apart by a known distance 76. The significance of a patterned reflective configuration, and in general a predetermined spatial relationship between reflectors, is discussed further below.

FIG. 15 shows another example of a reflector 60 placed in a target area 64 that excludes an area 70 of an expected motion path 72, for example, a small area around a golf tee. The reflector 60 only covers the target area 64, and so likewise is absent from the excluded area 70. In FIG. 15, if the actual motion path of the subject's swing imitates the expected motion path 72, the radiation detector of the apparatus 10 detects reflected radiation for most of the portion of the actual motion path approaching and leaving the excluded area 70, but does not detect radiation (as none is reflected) as the actual motion path crosses the excluded area. In this example, the behavior control feedback indicating “success” may be the absence of an indication, for example.

In view of the foregoing examples, it should be appreciated that the apparatus 10 zo and one or more reflectors 60 of the performance feedback systems 100 and 101 of FIGS. 12 and 13 may be arranged in a variety of configurations such that behavior control feedback in the form of either a sensory indication (an “active” indication) or the absence thereof (a “passive” indication) may indicate “success” or “failure” to a subject; in each case, the systems 100 and 101 provides some form of behavior control feedback to the subject in the form of one or more active or passive indications.

By repeating a movement task a number of times, the behavior control feedback provided by various embodiments of methods, apparatus, and systems according to the invention allows a subject to learn to perform a movement task with progressively increased precision, based on the subject's interpretation of the feedback. Furthermore, once the subject attains a certain level of “success” given a particular target area or arrangement of target areas, the size of the target area and the arrangement of target areas may be changed, or the range of a desired measurable performance goal may be reduced, such that the subject is required to attain progressively greater precision in executing the task. As discussed earlier, methods, apparatus, and systems of the invention effectively provide several learning and performance optimization advantages, at least one of which is the ability to provide essentially instantaneous feedback to the subject in a convenient, portable and non-invasive manner, thereby allowing the subject to learn a movement task in some sense at a subconscious level without being distracted from the performance of the task.

With respect to movement precision, again referring to the performance feedback systems shown in FIGS. 12 and 13, in one embodiment of the invention one or more reflectors 60 are located remotely from the apparatus 10 to allow the system to provide behavior control feedback for movement tasks with high resolution. In one aspect of this embodiment, the output power of the radiation source and the sensitivity of the detector of the apparatus 10 determine the distance over which the apparatus is effective. The precision of movement detectable by the system according to this embodiment depends, in part, on the spatial distribution of the radiation at the reflector and the aperture and type of the detector. Furthermore, since in one aspect the source and the detector may be co-located, which in some configurations means that the radiation is emitted from the source at approximately the same angle that it is incident to the detector from the reflector, or that the emitted and detected radiation are essentially parallel, using a mirror for one or more reflectors 60 decreases the portion of the movement task in which the detector detects radiation reflected from the reflector. As a result, higher precision movement may be detected using one or more mirrors for the at least one reflector 60.

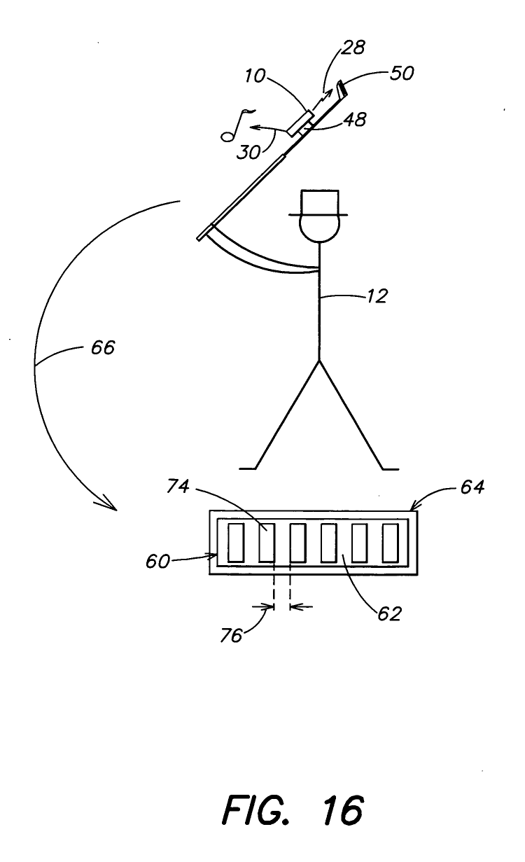

As discussed above, one or more reflectors of the system of FIGS. 12 and 13 may include a patterned reflective configuration. FIG. 16 shows essentially the scenario of FIG. 2, wherein a reflector 60 covering the target area 64 includes a patterned reflective configuration 62 of reflective patches 74 spaced apart by a known distance 76. In FIG. 16, the behavior control feedback 30 is assumed to be one or more audible indications, for purposes of illustration. As the subject 12 swings the golf club 50 across the target area 64 of FIG. 16, a series of audible indications are provided by the apparatus 10 as the behavior control feedback 30, as the radiation is reflected from each of the individual reflective patches 74. Each audible indication of the series of audible indications corresponds to a radiation detection event. From this example, it should be readily appreciated that, in general, a wide variety of patterned reflective configurations 62 can be implemented on one or more reflectors 60 in one or more target areas of a performance feedback system according to the invention to provide some particular form of instantaneous or aggregate behavior control feedback based on the patterned reflective configuration.

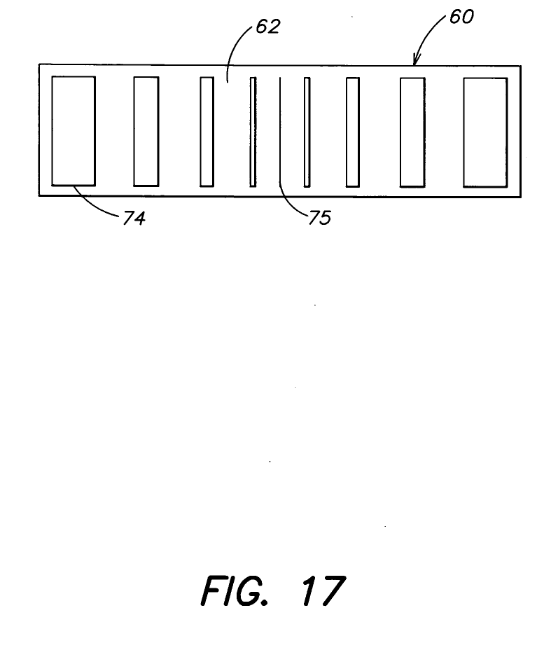

For example, FIG. 17 shows a reflector 60 having a patterned reflective configuration 62 in which wider strips of reflective material 74 are placed farther from a central portion 75 of the reflector 60, and narrower strips of reflective material are placed closer to the central portion. By employing such a reflector in the example system shown in FIG. 16, the behavior control feedback 30 may inform the subject of the proximity of the movement task 66 to a central portion of the target area 64, based on a duration and/or repetition rate of the indications constituting the behavior control feedback, for example. Of course, a reflector such as that shown in FIG. 17 may be used with any performance feedback system according to the invention. Another example of a patterned reflector suitable for a performance feedback system according to the invention includes a bar code.

As discussed above, various types of aggregate information can also be compiled from individual indications or radiation detection events to provide aggregate behavior control feedback according to one embodiment of the invention. The individual radiation detection events may result from one or more patterned reflective configurations, such as bar codes, or several discrete reflectors having predetermined spatial relationships. For example, referring to the reflector shown in FIG. 14, by knowing the distance 76 between reflective strips 74, the velocity of a movement task can be determined from the time between individual radiation detection events.

In general, by patterning a reflective configuration in a particular manner (e.g., by placing reflective strips or patches at predetermined locations and orientations throughout one or more reflectors covering one or more target areas), and/or by placing discrete reflectors throughout one or more target areas in an expected motion path of the object, proximate to an expected motion path, or in some predetermined spatial arrangement with respect to the expected motion path, a variety of motion information related to a motion of an object, position information related to a position of the object, and orientation information related to an orientation of the object as the object traverses one or more target areas may be determined, based on detected radiation that is reflected from the one or more reflectors.

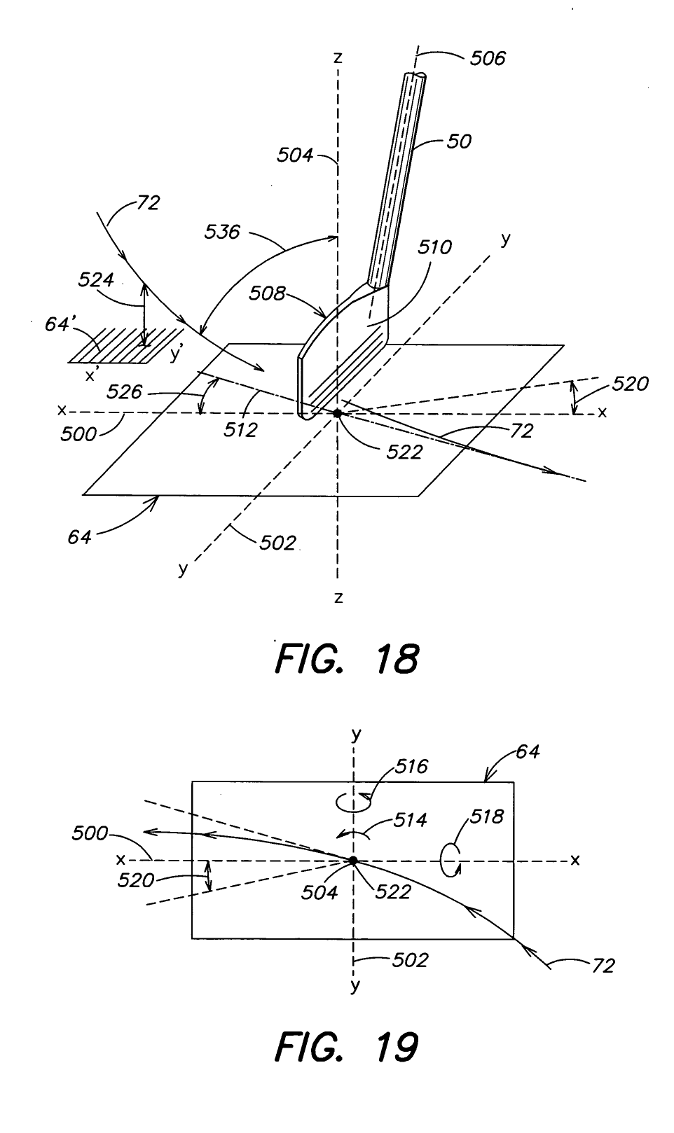

In particular, again using the example of swinging a golf club, a variety of position, motion, and orientation information related to the golf club as the golf club is swung across one or more target areas may be determined according to one embodiment of the invention. Behavior control feedback in turn can be provided to the subject who is swinging the golf club based on such information. As an aid for describing various position, motion, and orientation information that may be determined for the golf club during the swing, FIG. 18 illustrates a front perspective three-dimensional view of a golf club 50 at some point along a swing path 72 through a particular target area 64. Similarly, FIG. 19 illustrates a top perspective two-dimensional view of the swing, looking down onto the target area 64.

Although the following discussion relating to position, motion, and orientation information uses an exemplary application of a golf club being swung to impact a golf ball or virtual golf ball, it should be appreciated that the invention is not limited in this respect. In particular, the invention may be readily employed in other applications involving other types of sporting implements, which may or may not involve projectiles or projectile impact. In general, the principles discussed below may be applied to the analysis of any movement task via methods, apparatus, and systems according to the invention to provide feedback to the subject.

In both FIGS. 18 and 19, the target area 64 is represented by a three-dimensional coordinate system including an x-axis 500, a y-axis 502, and a z-axis 504, wherein each axis is perpendicular to each other and passes through a reference point 522 in the target area 64. In each of FIGS. 18 and 19, the x-axis 500 and the y-axis 502 define a plane 64′ (shown in FIG. 18 as a small shaded area for purposes of illustration) that includes the target area 64, and the z-axis 504 is perpendicular to the plane 64′. For example, the top perspective view of FIG. 19 is looking down onto the plane of the target area 64 along the z-axis 504.

From FIG. 19, it can be appreciated that a golf ball or virtual golf ball (or any other projectile germane to another movement task, for example, in a sporting environment) placed at the reference point 522 in the target area 64 would travel essentially along the x-axis 500 in a direction toward the left when impacted by the golf club traveling along the swing path 72 from the right. With reference to FIG. 18, a golfer “addressing” the golf ball during preparation for a swing typically aligns the golf club 50 so that a bottom edge of a face 510 of a club head 508 of the golf club is essentially parallel to the y-axis 502.

For purposes of the present disclosure, a “successful swing” of the golf club is one in which a trajectory of a golf ball or virtual golf ball impacted by the golf club during the swing falls within a predetermined trajectory angle 520 from the x-axis 500. In one aspect of the invention, a successful swing may be defined by a trajectory angle 520 equal to or less than approximately ±10° from the x-axis 500. In another aspect, a successful swing may be defined by a trajectory angle 520 equal to or less than approximately ±5° from the x-axis 500. In yet another aspect, a successful swing may be defined by a trajectory angle 520 equal to or less than approximately ±3° from the x-axis 500.

With reference to both FIGS. 18 and 19, a variety of position, motion, and orientation information of the golf club 50 with respect to the target area 64 may be determined as the golf club 50 traverses the target area, as discussed above. For example, as shown in FIG. 18, one or more object distances 524 of the golf club 50 from the plane 64′ as the object traverses the target area may be determined. An object distance 524 is parallel to the z-axis 504 and may be determined, for example, by placing a number of reflectors 60 in other target areas (not shown) in the plane of the target area 64, at various positions along, proximate to, or in some known relationship to an expected motion path of the golf club 50. A variety of laser distance measurement methods and apparatus are known in the art and described, for example, in U.S. Pat. Nos. 4,929,082, 4,926,050, 4,744,653, and 4492464, which applications are hereby incorporated herein by reference.

As also shown in FIG. 18, motion information related to the golf club 50 may include a motion path angle 526 of a projected actual motion path 512 of the golf club as the golf club traverses the target area 64. The projected actual motion path 512 is the swing path 72 as projected onto the plane 64′ (which includes the target area 64). The motion path angle 526 is defined by the projected actual motion path 512 and one of either the x-axis 500 and the y-axis 502. For example, FIG. 18 shows that the motion path angle 526 may be defined by the projected actual motion path 512 and the x-axis 500.

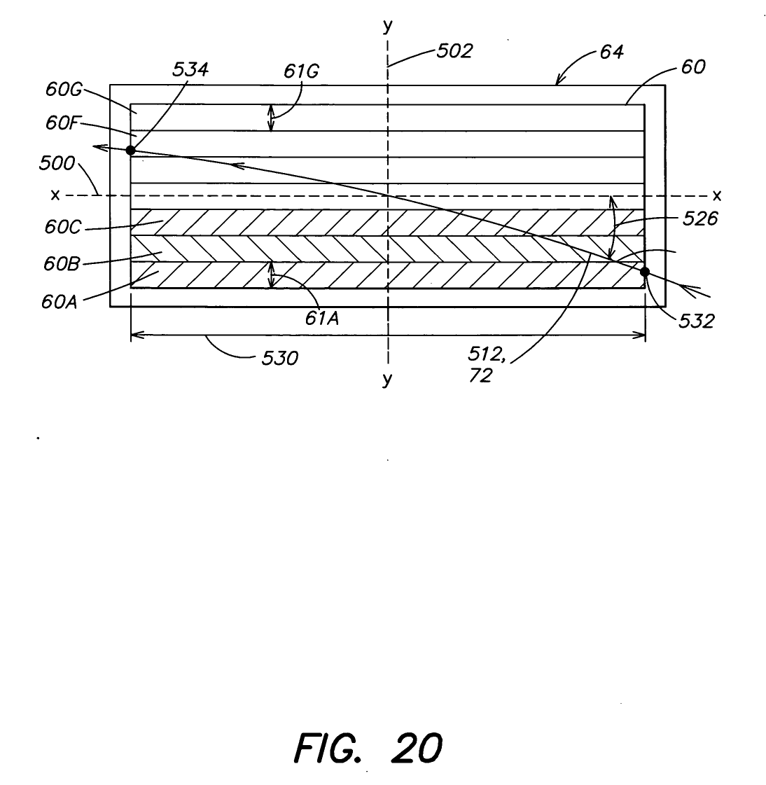

FIG. 20 shows an example of a reflector 60 placed in the target area 64 that may be utilized to determine the motion path angle 526 according to one embodiment of the invention. The reflector 60 of FIG. 20 is viewed from a top perspective view, similar to the view of FIG. 19. The reflector of FIG. 20 includes a number of horizontal strips 60A-60G each having a different polarization axis. While FIG. 20 shows the reflector 60 divided into seven horizontal strips, it should be appreciated that the reflector 60 may be divided into any number of horizontal strips according to different embodiments. In one aspect, the different polarization axes of the horizontal strips may be achieved by placing horizontal strips of thin polarizing films over a reflector in a predetermined manner.

The motion path angle 526 shown in FIG. 20 may be determined from known dimensions 61A-61G of each horizontal strip, a known polarization of each horizontal strip, and an overall dimension 530 of the reflector 60. For example, as a golf club equipped with an apparatus according to various embodiments of the invention is swung through the swing path 72, radiation from the apparatus impinges on the reflector 60 and is reflected therefrom with a particular polarization, depending on the particular horizontal strip of the reflector 60 from which the radiation is reflected. Accordingly, the projected actual motion path 512 in the plane of the target area 64 may be “mapped out” by sampling a number of radiation detection events throughout the swing and observing the different polarizations of the reflected radiation as the golf club traverses the reflector 60 in the target area 64. The motion path angle 526 may be calculated, for example, based on a polarization of detected radiation observed during an initial detection event at an entry point 532 (in section 60A of the reflector shown in FIG. 20), a polarization of detected radiation observed during a final detection event at an exit point 534 (in section 60F of the reflector shown in FIG. 20), the dimension 530 of the reflector, and the widths 61A-61G of each reflector section, using basic geometric principles.

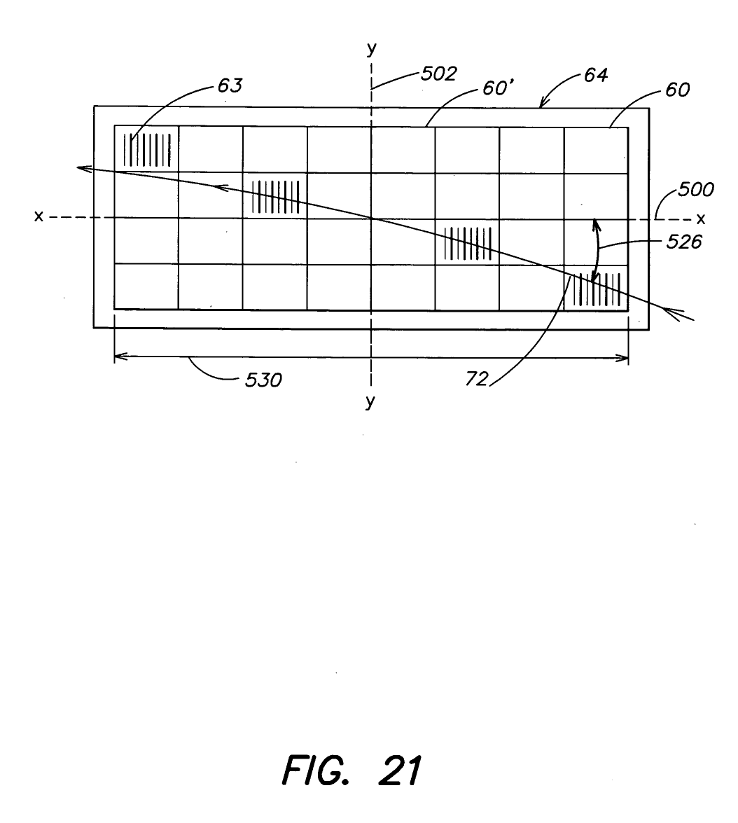

FIG. 21 shows yet another example of a reflector 60 placed in the target area 64 that may be utilized to determine the motion path angle 526 according to one embodiment of the invention. The reflector 60 of FIG. 21 is also viewed from a top perspective view, similar to the view of FIG. 19. The reflector of FIG. 21 includes a two dimensional grid 60′ of cells, each cell containing a unique bar code 63. It should be appreciated that the number of cells and the dimensions of the grid shown in FIG. 21 are for purposes of illustration only, and that other arrangements, sizes, and distributions of cells may be suitable for purposes of the invention.

In a manner similar to that discussed above in connection with FIG. 20, as a golf club equipped with an apparatus according to various embodiments of the invention is swung through the swing path 72 in FIG. 21, radiation from the apparatus impinges on the reflector 60 and is reflected therefrom with a particular modulation, depending on the bar code in the cell of the reflector 60 from which the radiation is reflected. Accordingly, the projected actual motion path 512 in the plane of the target area 64 may be “mapped out” by sampling a number of radiation detection events throughout the swing and observing the different bar code modulations of the reflected radiation as the golf club traverses the reflector 60 in the target area 64. By knowing the position in the grid of each unique bar code, the grid and cell dimensions, and the reflector dimensions, the motion path angle 526 may be calculated from basic geometric principles in a manner similar to that discussed above in connection with FIG. 20.

With reference again to FIGS. 18 and 19, motion information of the golf club as the golf club traverses the target area 64 may also include an approach angle 536. The approach angle 536 is essentially defined between the swing path 72 and either the z-axis 504 or the plane 64′ including the target area 64 (i.e., as defined by the x-axis 500 and the y-axis 502). For example, as shown in FIG. 18, the approach angle 536 may be defined essentially between the z-axis 504 and the swing path 72. In one embodiment of the invention, the approach angle 536 may be determined by measuring a number of distances 524 throughout an approach of the swing as the golf club 50 is brought toward the target area 64. The approach angle 536 may then be determined from the distances 524 and the motion path angle 526 based on basic geometric principles.

As discussed above, a variety of orientation information may also be determined in connection with the golf club 50 relative to the target area 64 as the golf club traverses the target area. As shown in FIG. 18, the golf club 50 may be represented by an axis 506 along a shaft of the golf club. With reference to FIG. 19, according to one embodiment of the invention, an orientation of the golf club axis 506 may be determined with respect to the coordinate system of the target area 64. In particular, the orientation of the golf club axis 506 may be described in terms of a yaw angle 514, or rotation of the golf club 50 about the z-axis 504, a pitch angle 516, or rotation of the golf club 50 about the y-axis 502, and a roll angle 518, or a rotation of the golf club 50 about the x-axis 500. In golfing environments, the terms yaw angle, pitch angle, and roll angle are synonymous with club face angle, loft angle, and lie angle, respectively. In one embodiment, a 0° reference for each of the foregoing rotation angles may be given in terms of the golf club axis 506 being aligned with the z-axis 504 (i.e., vertical to the plane 64′ of the target area 64) with a bottom edge of the club head 508 aligned essentially along the y-axis 502.

Applicants have recognized that while the various position, motion, and orientation information of the golf club 50 described above may be useful for providing behavior control feedback to a subject, one of the more significant pieces of information related to a successful swing, or a swing that results in a projectile or virtual projectile trajectory within a desirable predetermined trajectory angle 520 of the x-axis 500 (e.g., a trajectory angle 520 equal to or less than approximately ±5°) is the yaw angle (or club face angle) 514.

In view of the foregoing, according to one embodiment, the invention provides instantaneous behavior control feedback to a subject by indicating to the subject if the swing is successful, and namely, if a club rotation angle of the golf club as the golf club traverses the target area is within a predetermined range. The club rotation angle differs from the yaw or club face angle 514 in that the club rotation angle describes the rotation zo of the club head 508 around the golf club axis 506 with respect to the y-axis 502 of the target area 64, wherein the club axis 506 is not necessarily aligned parallel to the z-axis 504. It should be appreciated, however, that based on basic geometric principles, the yaw or club face angle 514 is related to the club rotation angle through one or both of the pitch angle 516 and the roll angle 518. Accordingly, for purposes of the present invention, a determination of a club rotation angle is significantly indicative of the yaw or club face angle 514, and provides useful information for determining the success of a golf swing. Additionally, it should be appreciated in general that the determination of any of the aforementioned position, motion, and orientation information need not be necessarily performed with a high degree of accuracy to nonetheless provide useful feedback.

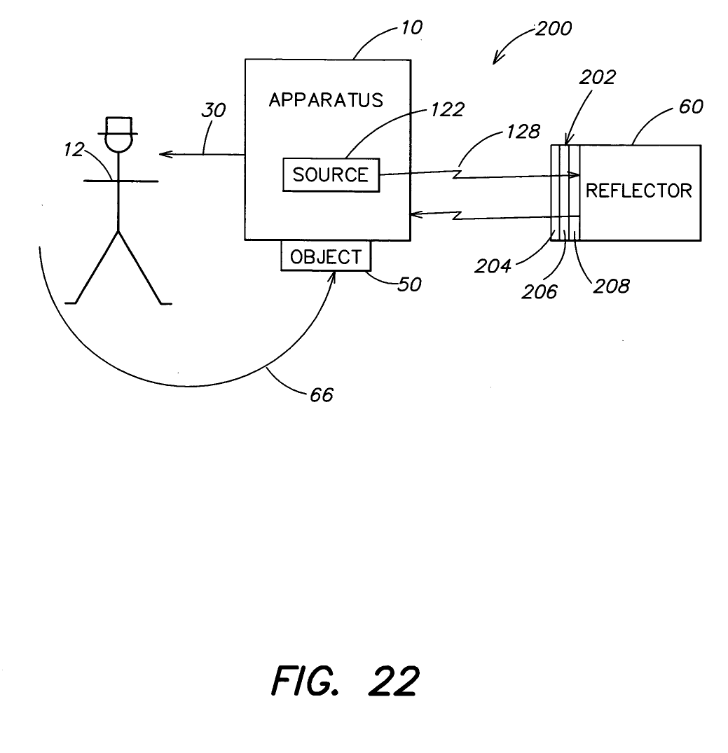

FIG. 22 shows an example of a performance feedback system 200 according to another embodiment of the invention. The performance feedback system 200 of FIG. 22 is particularly useful for providing behavior control feedback based on an orientation of an object in connection with the performance of a task. In particular, the system 200 is useful for providing behavior control feedback based on an object rotation angle of the object about an axis through the object, relative to an axis of a particular target area.

The system 200 of FIG. 22 includes one or more apparatus 10 having a source 122 to emit polarized radiation 128. Alternatively, apparatus 10 may include a source to emit random or unpolarized radiation which passes through a discrete polarizing element (not shown in FIG. 22) that is included in the apparatus to provide polarized radiation 128. Polarized radiation 128 may be, for example, linearly polarized radiation, or circularly polarized radiation.

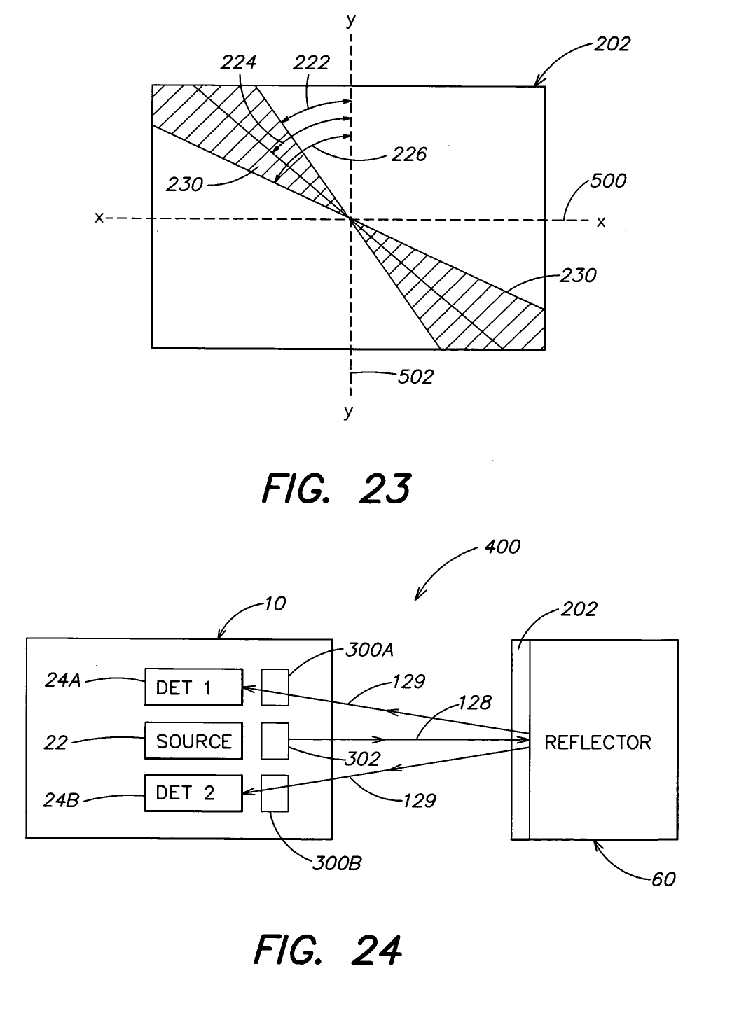

In the embodiment of FIG. 22, the reflector 60 on which the polarized radiation 128 impinges includes one or more polarizing filters 202 having a predetermined polarization orientation, such that the reflector 60 selectively reflects radiation having the predetermined polarization orientation. FIG. 23 shows a top perspective view similar to that of FIG. 19 of the polarization filter 202, namely, a view of the plane of a target area to which the polarized radiation 128 is incident. One example of a predetermined polarization orientation of the filter 202 with respect to the y-axis 502 is indicated by reference character 222.

With reference again to FIG. 22, in one aspect of this embodiment, an example of a polarizing filter 202 may include a plurality of polarizing films 204, 206, and 208 assembled in a stack. While FIG. 22 shows three polarizing films, any number of such films (one or more) may be used for the polarizing filter 202. Each polarized film 204, 206, and 208 may have a unique predetermined polarization orientation, as indicated in FIG. 23 by reference characters 222, 224, and 226, respectively, such that the polarizing filter 202 has a polarization orientation “window”, indicated by shaded area 230. In this aspect of the embodiment of FIG. 22, the reflector 60 selectively reflects polarized radiation 128 having a polarization orientation within the window 230.

The performance feedback system 200 of FIG. 22 is useful for providing feedback in connection with orientation, in that only radiation having a particular polarization orientation, or having a polarization orientation within a particular range, is reflected from reflector 60. Hence, if the polarization of the polarized radiation 128 is known with respect to some reference position associated with the object 50 (e.g., with respect to the plane of the club face of a golf club), the system 200 can be used to optimize the orientation of the object 50 with respect to the y-axis 502 as the object passes through a motion path that includes the reflector 60, by providing feedback based on the relationship of the orientation of the object with respect to the polarization orientation or polarization orientation window of the polarizing filter.

In particular, with reference to both FIGS. 19 and 23, if the object is swung on the swing path 72, the polarization orientation window 230 and the polarization of the radiation 128 may be selected such that the subject receives an indication only when the object is oriented within a particular angular window about the y-axis 502 as the object traverses the target area. This orientation in turn provides some indication as to an anticipated trajectory, with respect to the x-axis 500, of a projectile (or virtual projectile) impacted by the object.

FIG. 24 illustrates yet another example of a performance feedback system 400 according to one embodiment of the invention. Like the system 200 of FIG. 22, the performance feedback system 400 of FIG. 24 is particularly useful for providing behavior control feedback based on an orientation of an object in connection with the performance of a task. The system 400 of FIG. 24 includes one or more apparatus 10 which, in various aspects, may be similar to (include components similar to) the apparatus 10 shown in any of the preceding figures. Accordingly, for purposes of simplicity, only some components of the apparatus 10 are shown in FIG. 24, so as to focus on those features that may be different with respect to other embodiments of the apparatus 10. In particular, the apparatus 10 shown in FIG. 24 includes at least two radiation detectors 24A and 24B, and at least two polarizing elements 300A and 300B to polarize radiation incident to each of the detectors 24A and 24B.

In the system of FIG. 24, the source 22 of the apparatus 10 emits polarized radiation 128. The polarized radiation 128 may be, for example, linearly polarized. Alternatively, the apparatus 10 optionally may include a quarter wave plate 302 to convert linearly polarized radiation emitted by the source 22 to circularly polarized radiation. The quarter wave plate 302 may be, for example, a birefringent retardation plate that retards radiation with one polarization by one quarter wavelength more than radiation with an orthogonal polarization. In one aspect of this embodiment, a polarization axis of the quarter wave plate 302 is oriented at 45° with respect to the linear polarization of the radiation emitted by the source 22. Such an arrangement leads to circularly polarized radiation 128 exiting the apparatus 10. Circularly polarized radiation is radiation having equal amplitude in two orthogonal polarization directions, but with the two polarization directions differing in their temporal phase by one quarter cycle. Stated differently, a field vector (electric or magnetic) of the circularly polarized radiation 128 is perpendicular to, and rotates in a circle about, a propagation axis of the radiation 128.

In the system of FIG. 24, the polarized radiation 128, whether linearly or circularly polarized, impinges upon the reflector 60 after passing through a polarizing filter 202. The polarizing filter 202 has a particular polarization axis, and permits only that portion of the polarized radiation 128 having a polarization parallel to the polarization axis of the polarizing filter 202 to pass on to the reflector 60. Hence, the polarizing filter 202 imparts a particular linear polarization to the radiation as the radiation passes through the polarizing filter. It should be appreciated that, in this process, some of the radiation incident to the polarizing filter 202 may not be transmitted, and is hence lost.

Radiation 129 that has passed through the polarizing filter 202 (i.e., having the polarization of the polarizing filter) subsequently impinges upon the reflector 60, is reflected back along its incoming path, and passes a second time through the polarizing filter. Since the reflected radiation 129 is already polarized in a direction parallel to the polarization axis of the polarizing filter 202, there is typically no additional loss. In the foregoing process, it should be appreciated that the polarization of the reflected radiation 129 is determined by the polarization axis of the polarizing filter 202, and is not necessarily related to the original polarization of the radiation 128 emitted from the apparatus 10.

As the linearly polarized reflected radiation 129 returns from the reflector 60 toward the apparatus 10, the radiation 129 impinges upon two separate detectors 24A and 24B. In FIG. 24, the reflected radiation 129 is shown as going along two separate paths, one to each detector. This depiction is primarily for purposes of illustration. In practice, the reflected radiation 129 may be reflected over a small angular range around the incoming radiation 128 impinging upon the polarization filter 202 and the reflector 60, and the detectors 24A and 24B may be positioned such that each detector detects a portion of the same returned radiation beam 129.

As shown in FIG. 24, the apparatus 10 also includes at least two polarizers 300A and 300B positioned in front of respective detectors 24A and 24B such that the reflected radiation 129 passes through each polarizer before impinging upon the detectors. The polarizers 300A and 300B are aligned so as to have different polarization orientations with respect to each other. In one aspect of this embodiment, the polarization orientations of the respective polarizers 300A and 300B are orthogonal to each other, as discussed further below.

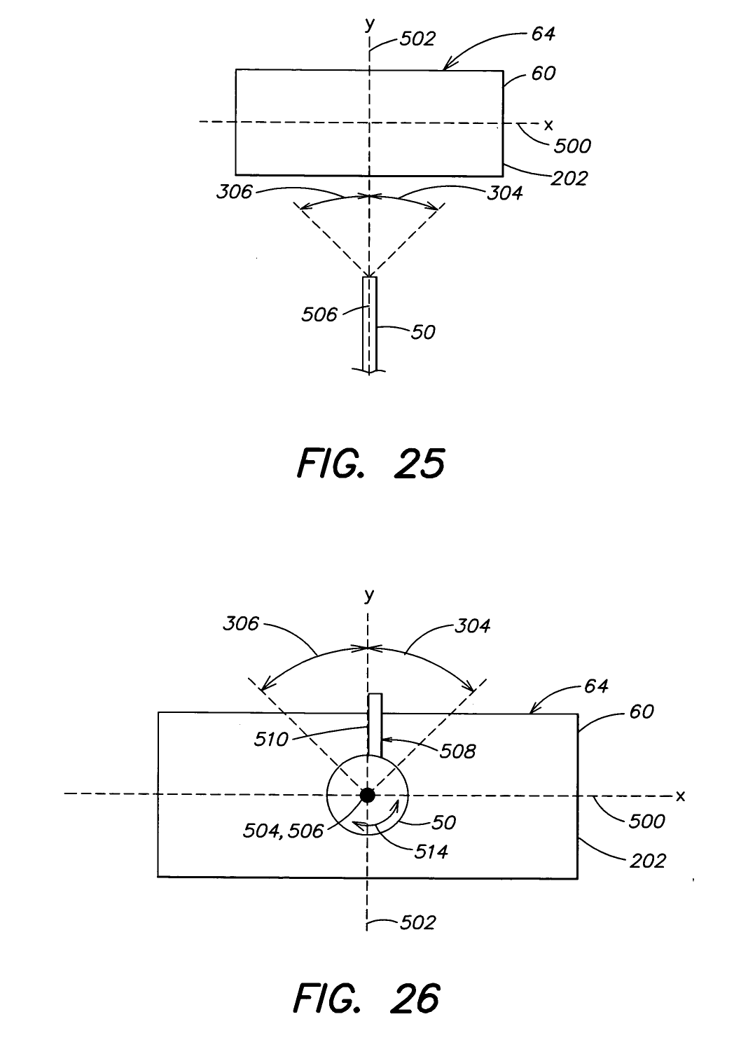

FIGS. 25 and 26 are top perspective views, similar to that of FIG. 19, showing a particular target area 64 including one or more reflectors 60 and the polarizing filter 202 of FIG. 24. FIG. 25 depicts a portion of an object 50 (e.g., a golf club) having an axis 506 projected, for purposes of illustration, along the y-axis 502 of the target area 64. It should be appreciated that, in practice, the object axis 506 generally would not be along the y-axis in the plane of the target area, as shown in FIG. 25, but would be somewhere in the three-dimensional coordinate space shown in FIG. 20, for example. FIG. 26 shows the object 50 looking down along the axis 506 of the object 50, which for purposes of illustration in FIG. 26 is coincident with the z-axis 504 (i.e., perpendicular to the plane of the target area 64). For purposes of the present discussion, the polarizing axis of the polarizing filter 202 is taken to be parallel to the y-axis 502, although it should be appreciated that other polarizing axes for the polarizing layer 202 are possible according to other embodiments of the invention.

FIGS. 25 and 26 each show the respective polarizing axes (polarization orientations) 304 and 306 of the polarizers 300A and 300B of the apparatus 10 shown in FIG. 24. In particular, FIGS. 25 and 26 show that the polarizing axes 304 and 306 are oriented at ±45° with respect to the polarization axis of the polarizing filter 202 which, as discussed above, is parallel to the y-axis 502 in this example. It should be appreciated that, in FIGS. 25 and 26, the polarizing axes 304 and 306 are ±45° with respect to the y-axis 502 when the object 50 has a “desired” rotation about the y-axis. For example, as shown in FIG. 26, if the object 50 is a golf club having a golf head 508 and an axis 506 through the golf club along the shaft of the golf club, a “desired” orientation of the golf club 50 relative to the y-axis 502 is one in which an edge of a club face 510 of the club head 508 is essentially parallel to the y-axis 502 (and hence, parallel to the polarization axis of the polarizing filter 202).

This particular orientation of the golf club 50 relative to the y-axis 502 is desirable, for striking a golf ball at this orientation likely sends the golf ball on a trajectory which is essentially parallel to the x-axis 500, and hence, constitutes a “successful” swing. The orientation of an edge of the club face 510 relative to the y-axis 502 of the target area is referred to as “club shaft rotation angle” for purposes of the present discussion. If the golf club axis 506 is coincident with the z-axis 504, the club shaft rotation angle is equivalent to the yaw angle 514, as shown in FIG. 26.

When the golf club 50 is oriented as shown in FIG. 26, the reflected radiation 129 is essentially linearly polarized along the y-axis 502, due to the polarizing filter 202. As discussed above, the respective polarizing axes 304 and 306 of the detectors 300A and 300B are oriented at ±45° with respect to the y-axis 502. Accordingly, at the orientation shown in FIG. 26, each detector 300A and 300B detects an equal amplitude of the reflected radiation 129. As the golf club 50 (to which the apparatus 10 is attached in this example) is rotated in one direction or the other about the golf club axis 506, one of the detectors 300A and 300B detects more radiation as its associated polarizer 300A or 300B becomes more nearly parallel to the y-axis 502, and the other detector detects less radiation as its associated polarizer becomes less parallel to the y-axis 502. It can be shown that the club shaft rotation angle about the axis 506 relative to the y-axis 502 is given by the relationship:

θ=tan⁻¹(D2/D1)−π/4,

where θ is the club shaft rotation angle in radians, D1 is the output signal from one of the detectors 24A and 24B, and D2 is the output signal from another of the detectors 24A and 24B. The above equation is valid for club shaft rotation angles in a range of approximately ±π/4 radians (±45°).

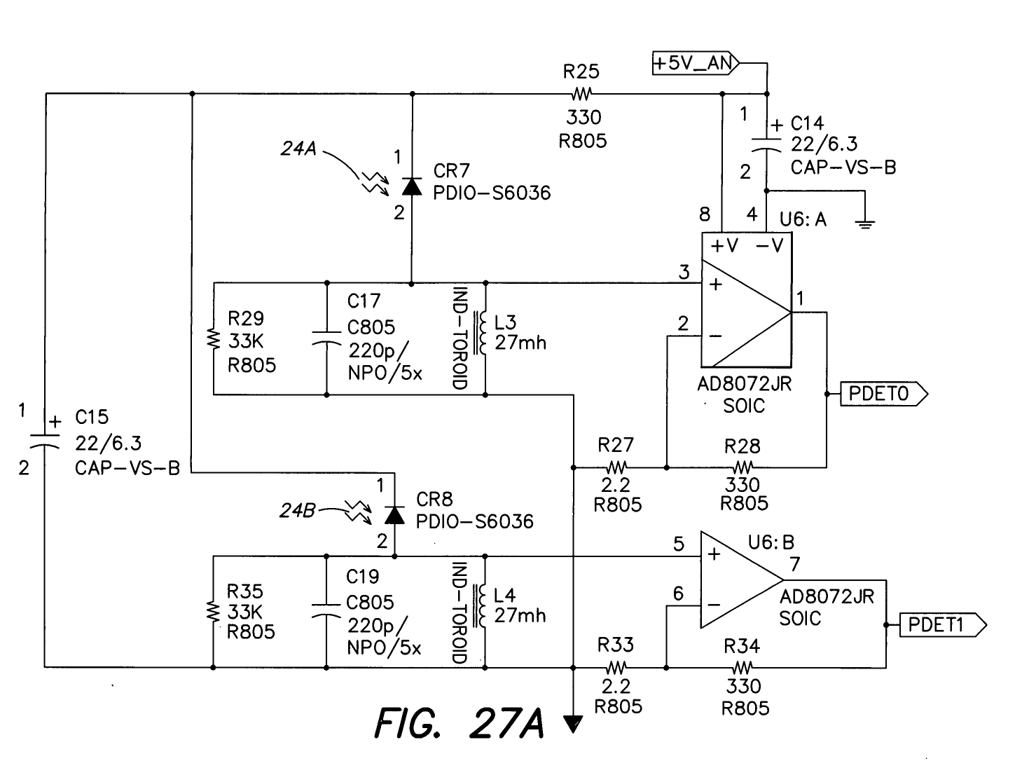

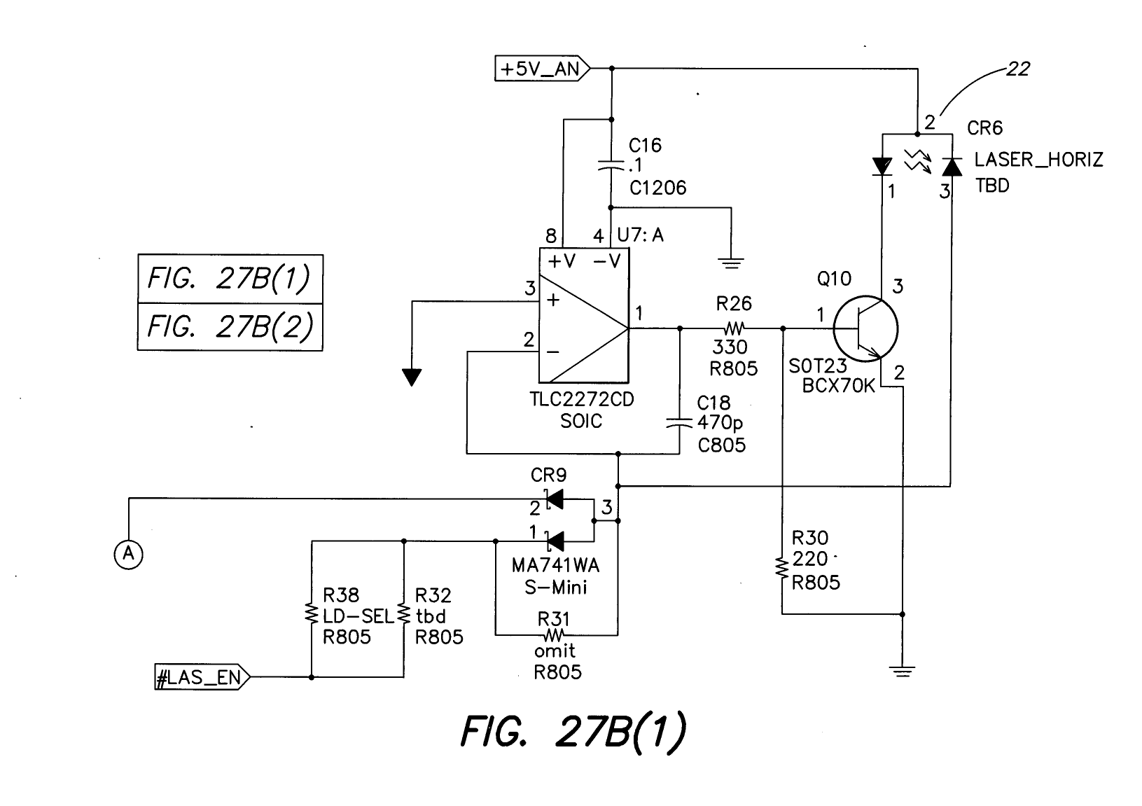

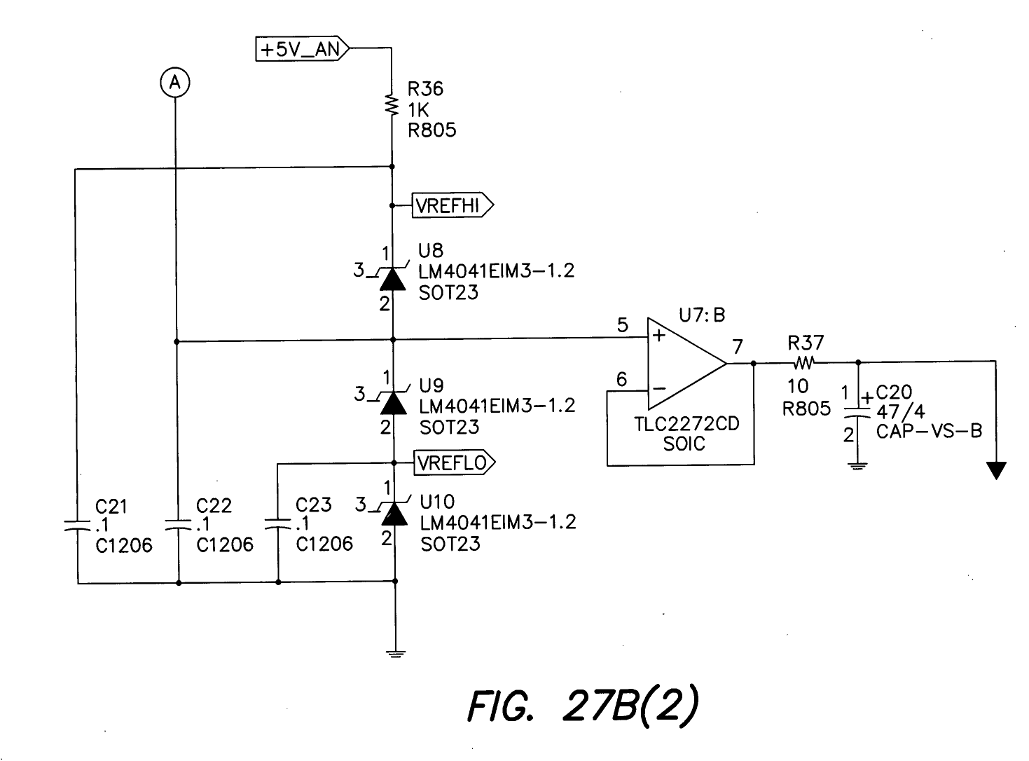

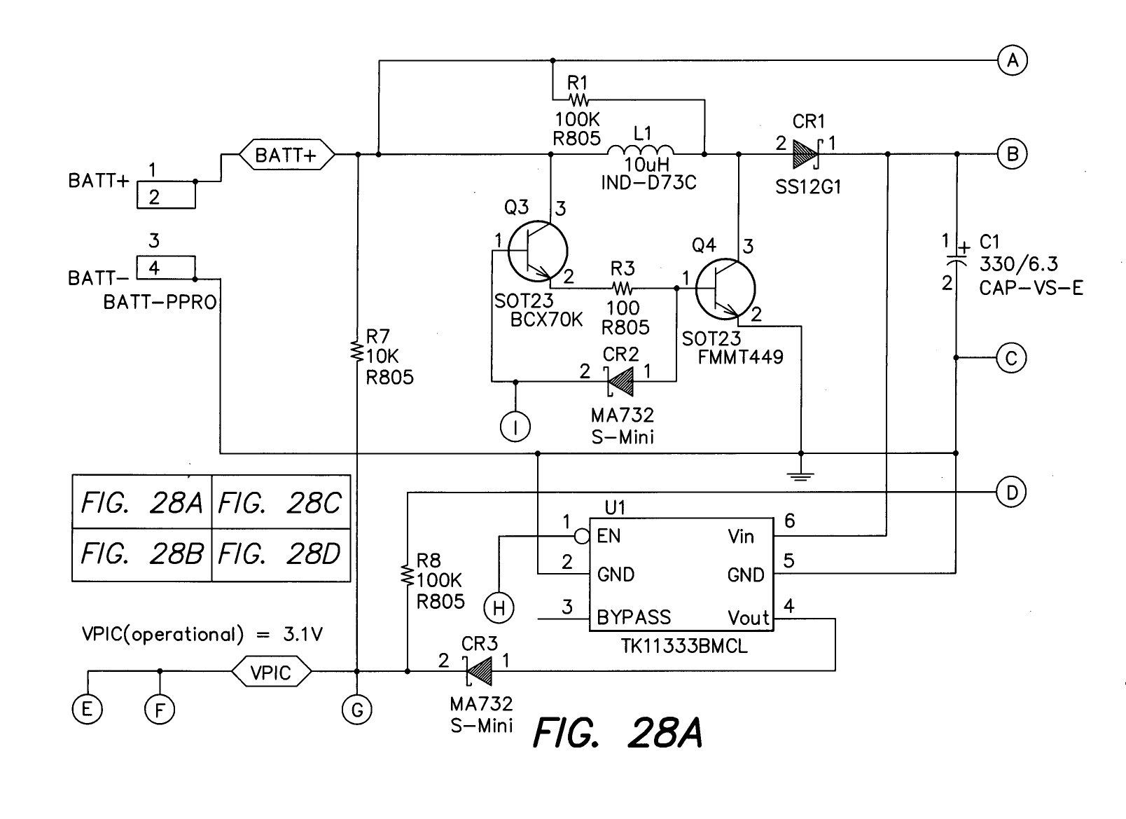

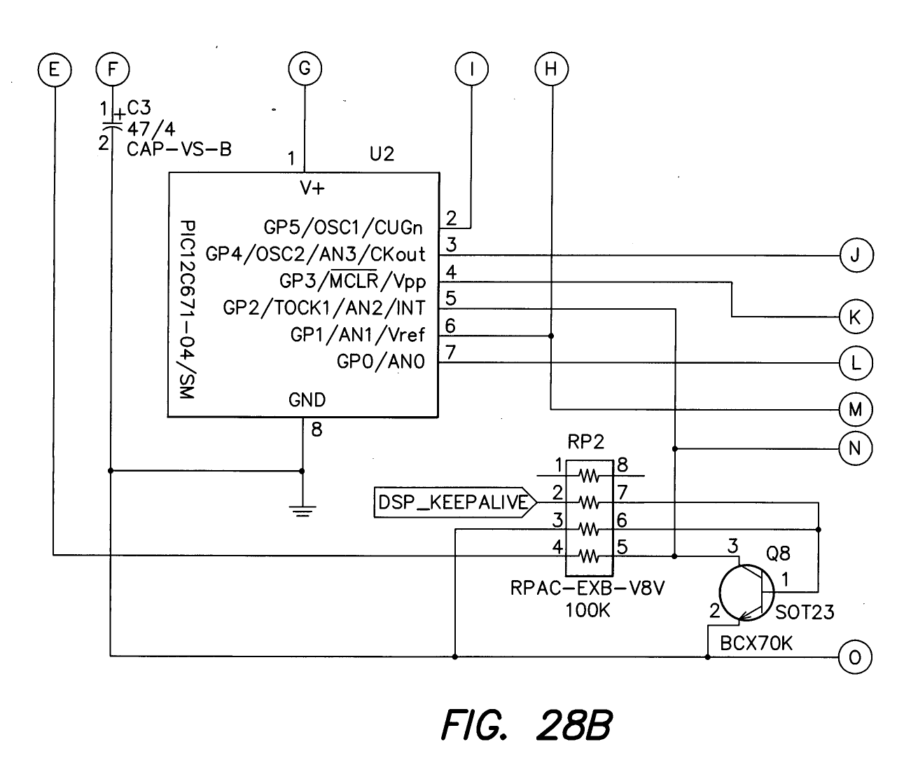

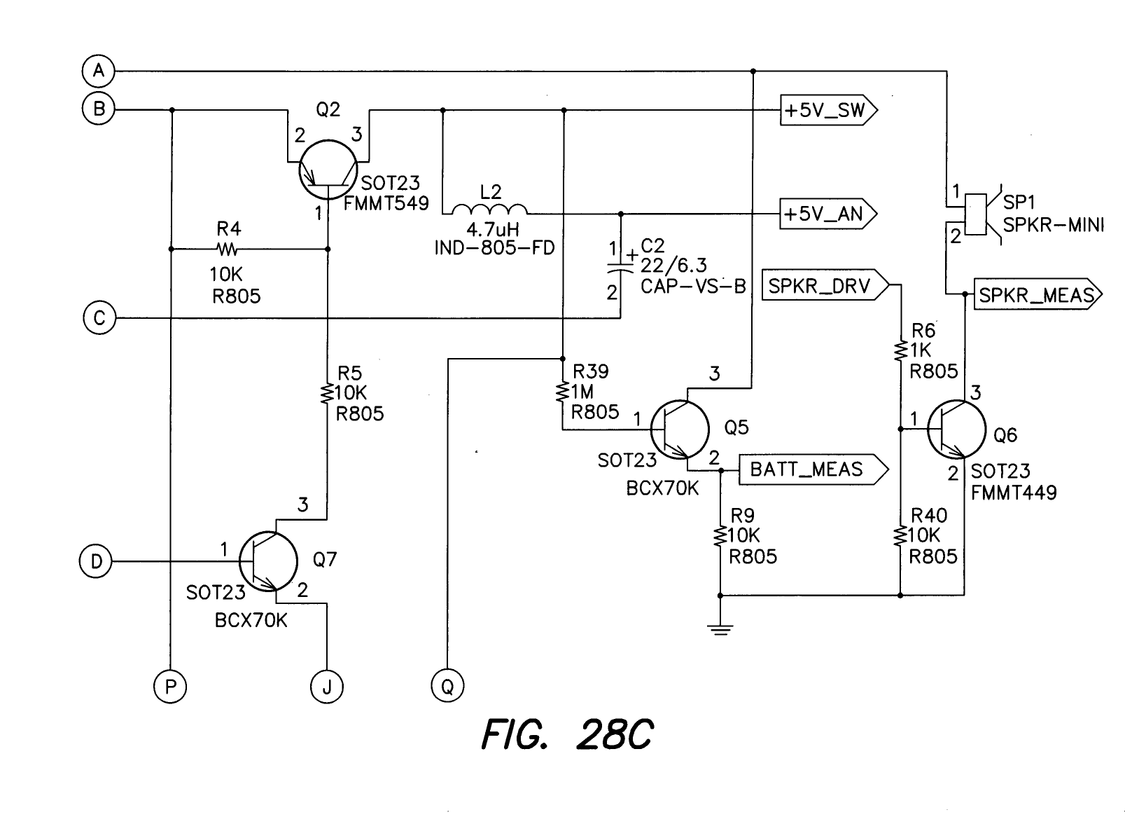

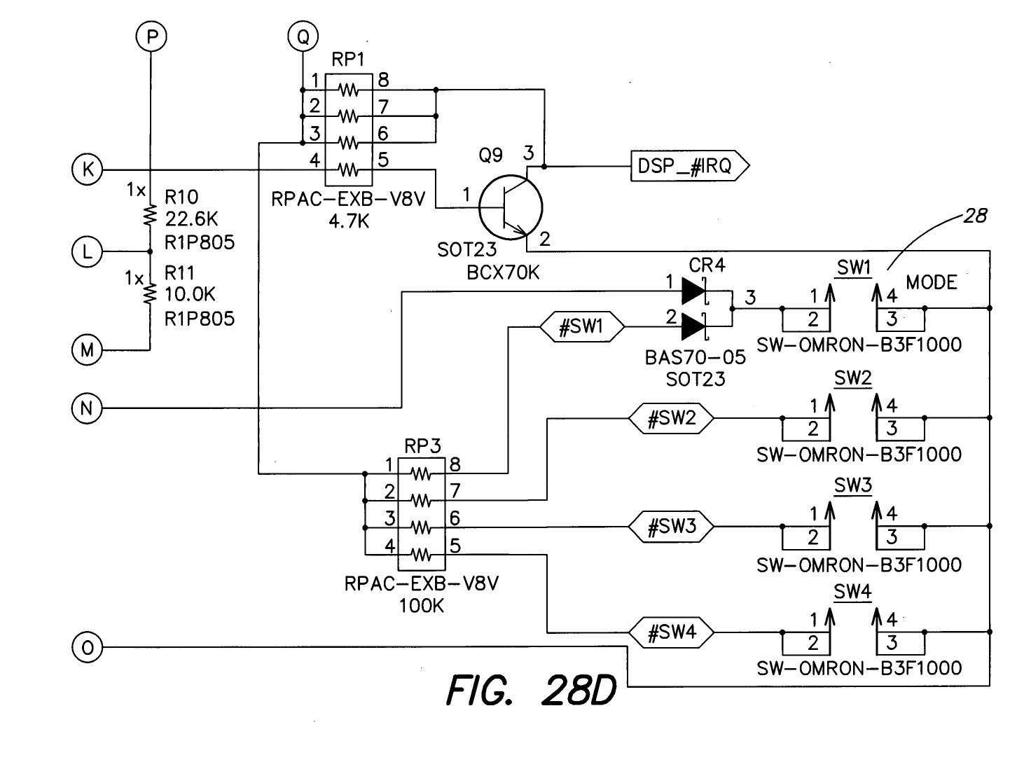

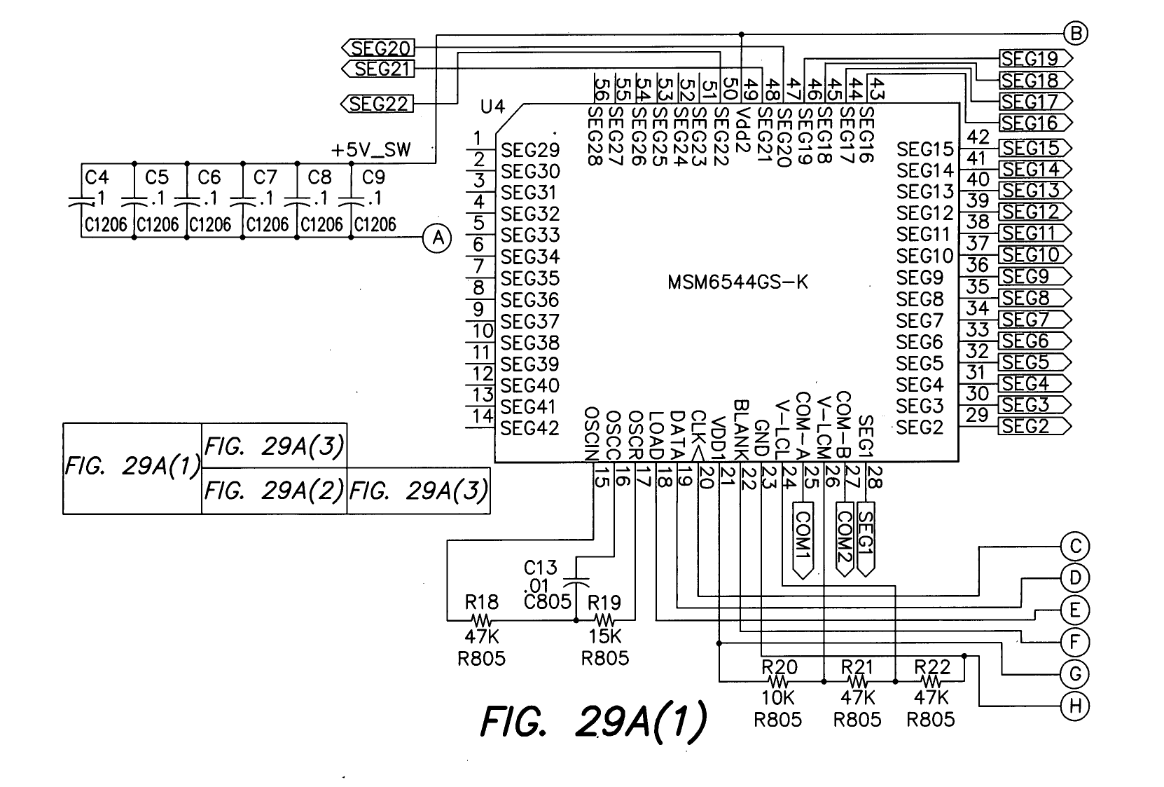

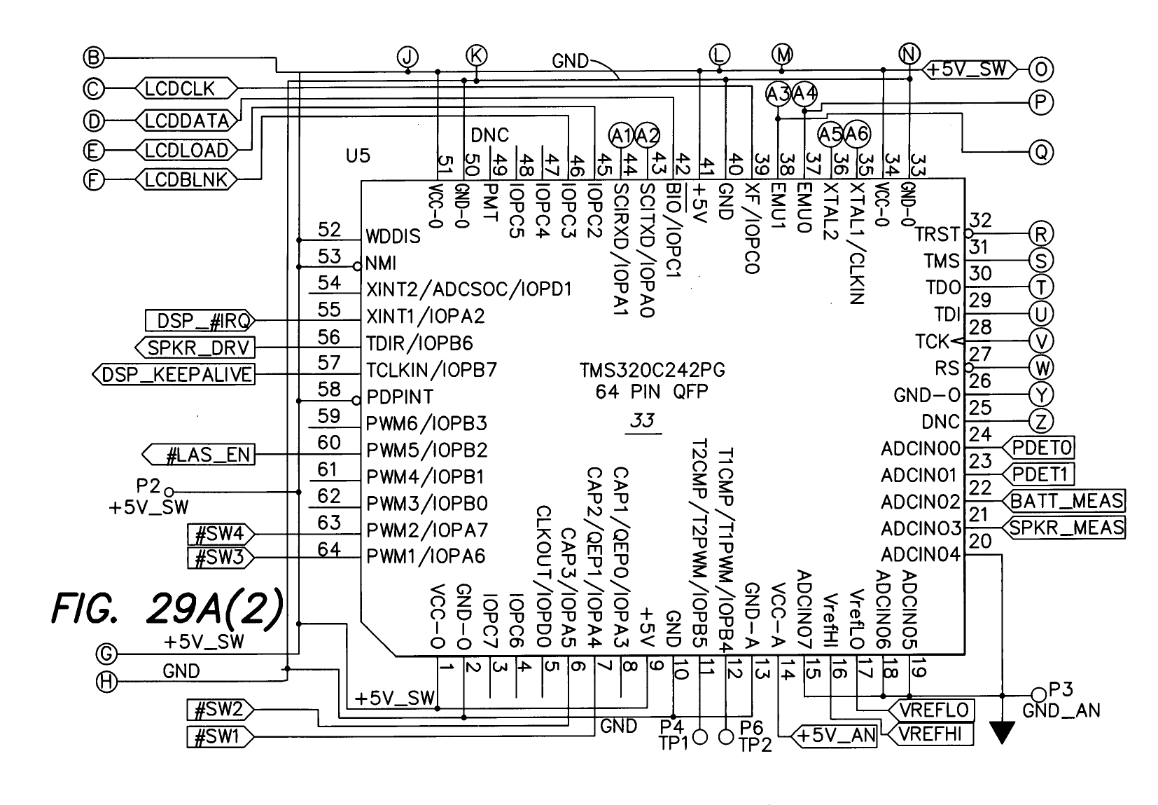

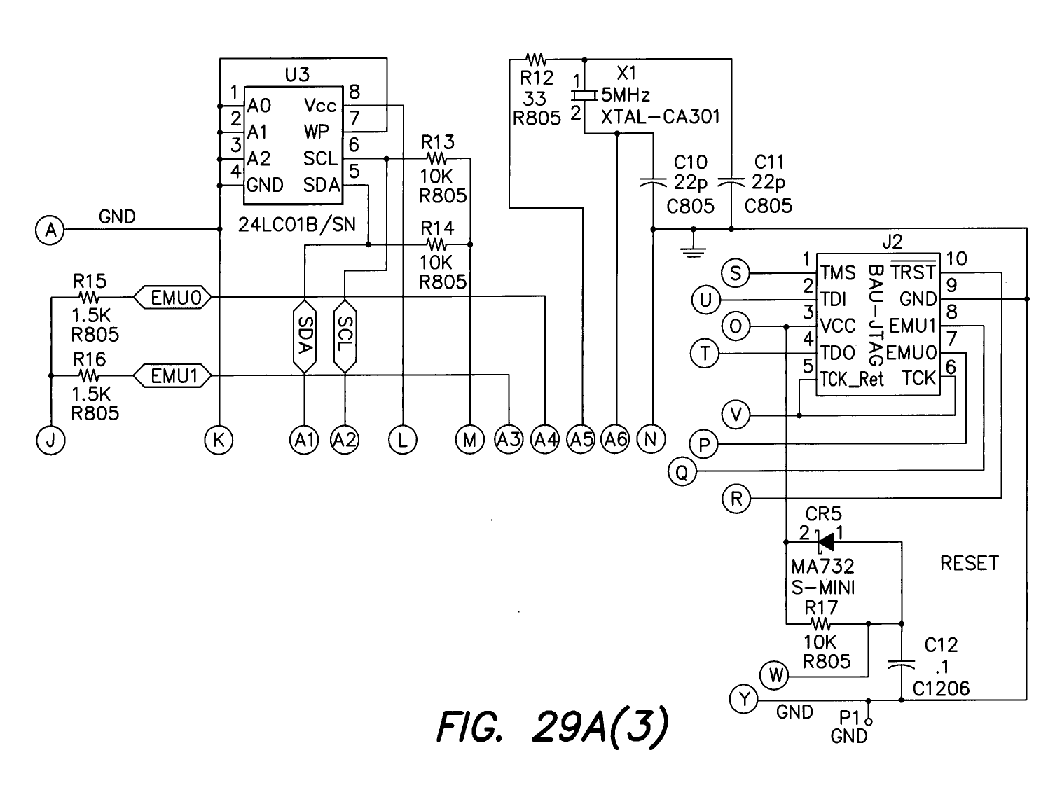

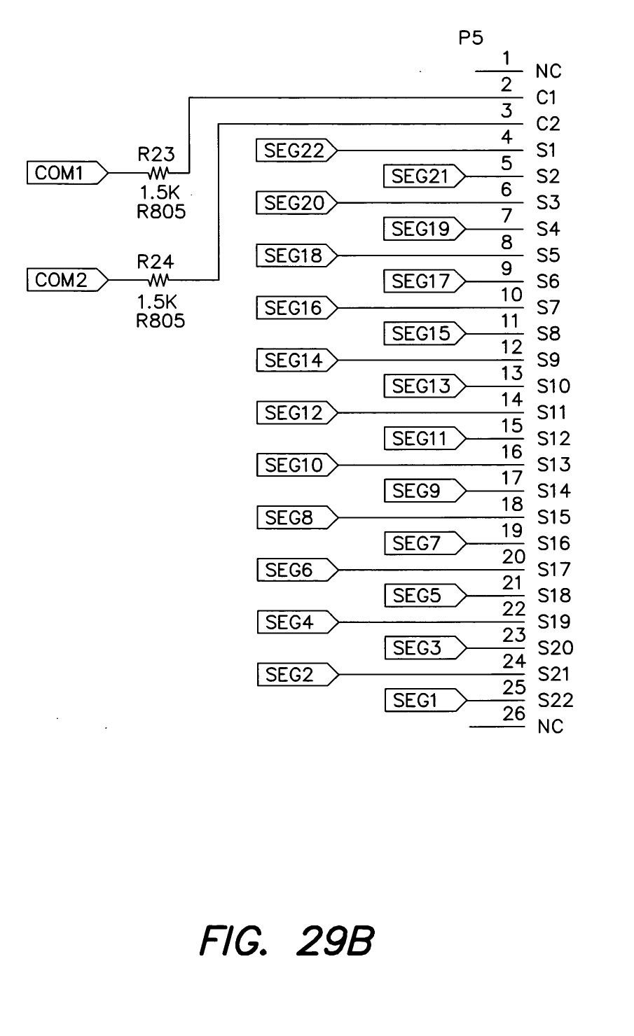

FIGS. 27-29 are diagrams showing one example of an electronic circuit implementation for the apparatus 10 employed in the system 400 of FIG. 24, according to one embodiment of the invention. It should be appreciated that the electronic circuit schematics of FIGS. 27-29 do not include any polarizing components. The device illustrated in FIGS. 27-29, including the processor 33 which coordinates the various functions of the device, is capable of detecting radiation, and in particular polarized radiation, and from the detected radiation the device can determine club shaft rotation angle within a range of at least ±30°, in 0.1° increments, with respect to the polarizing axis of the polarizing filter 202. It should be appreciated that the device may also measure a “club shaft twist rate” by performing a number of club shaft rotation angle measurements over time. Additionally, the device is capable of measuring club velocity in a range of from approximately 5-199 miles per hour (mph), in 1 mph increments, and swing “tempo” in a range of from approximately 0.25 to 3.0 seconds in 0.01 second increments. Swing tempo refers to the time between which the golf club traverses the target area 64 on a “takeaway” (wind up) of the swing, and when the club again traverses the target area during the swing, on the way to impacting a golf ball or virtual golf ball.

The device of FIGS. 27-29 permits the subject to select a “performance goal” for each of the aforementioned parameters via a user interface 38 (switches SW1-SW4 in FIG. 28). The device provides a variety of audio and visual behavior control feedback to the subject to help the subject approach the performance goals. For each parameter, the device also permits the subject to select and adjust different performance ranges associated with various skill levels. The device is capable of providing the subject with feedback that indicates whether the subject was within a particular performance range, or above or below some predetermined threshold criteria which may establish the boundaries of the performance range. For example, the device may provide an upward trailing audible frequency for performance above an upper boundary of a performance range, a downward trailing audible frequency for performance below a lower boundary of the performance range, and a stationary audible frequency for performance within the performance range.

From the foregoing exemplary embodiments, it should be appreciated that a variety of other position, motion, and orientation information related to an object traversing one or more target areas may be determined by various methods, apparatus, and systems according to other embodiments of the invention. One common component in many such embodiments includes one or more indicators 26, as shown for example in FIGS. 1, 4, 5, and 11. As discussed above, various indicators according to the invention may provide one or more audible, visible, or tactile indications based on one or more radiation detection events. Additionally, indicators may provide patterns of indications based on one or more audible, visible, and/or tactile indications. In particular, one or more indicators may provide sound, voice, alpha-numeric, and/or graphical indications based on radiation detection events or information (position, motion, orientation) derived from one or more radiation detection events. For example, an indicator may provide a voice indication such as “velocity is 50 miles per hour,” “club rotation angle is 4.5 degrees,” “club rotation angle is between 5 and 10 degrees,” “decelerating prior to impact,” “good swing!,” and the like.

Furthermore, according to one embodiment of the invention, one or more indicators 26 may provide complex graphical information to a subject in connection with the performance of a movement task, based on various position, motion, and orientation information. For example, one or more processors 33 of an apparatus according to the invention may determine a trajectory projection of a real or virtual projectile that is struck by an object operated by a subject to perform a movement task. In one aspect of this embodiment, the real or virtual projectile is situated in a particular target area, through which the subject swings the object, and a variety of motion, position, and orientation information is determined by the processor based on detected radiation as the subject swings the object through the target area. From such information, the processor 33 may determine the trajectory projection of the projectile based on basic principles of physics related to ballistics. As discussed above, the processor may include one or more computers which execute particular software or microcode to determine the trajectory projection from information derived from at least the detected radiation. In the case of impacting a real projectile, a determination of trajectory projection may also consider impact information derived from one or more impact sensors included in an apparatus according to one embodiment of the invention, as discussed above in connection with FIG. 4.

In one embodiment, one or more processors 33 according to the invention may include various types of memory storage to store information related to a real or virtual environment in which the subject performs the movement task. In this embodiment, one or more indicators may provide the subject with an indication (e.g., a graphical display) of the environment, and superimpose a trajectory projection as discussed above onto the indication of the environment. For example, in one aspect of this embodiment, the environment may include all or a portion of a real or virtual golf course (e.g., one or more fairways, greens, and “holes”) for which the indicator provides some graphical depiction or other indication (e.g., alpha-numeric read-out of distance from tee to one or more holes). Additionally, the indicator may superimpose a real or virtual golf ball trajectory projection onto a graphical depiction of the golf course, based on one or more swings of a golf club across the target area. In yet another aspect of this embodiment, the processor may include a comparator to make a comparison of the trajectory projection and the information related to a particular environment, and provide a variety of behavior control feedback to the subject based on the comparison (e.g., “hole in one!”).

As should be readily appreciated from the foregoing illustrative examples, methods, apparatus, and systems of the present invention may find application in a host of sporting, gaming, recreational, exercise, and fitness applications. For example, an apparatus according to various embodiments of the invention can be attached to the wrist is of a bowler and one or more reflectors placed on one or more target areas in the vicinity of a bowling lane to provide the bowler with behavior control feedback relating to the delivery of the bowling ball down the lane. Similarly, several other tossing, throwing, or aiming activities, such as throwing or kicking a ball, aiming and throwing a dart or a horseshoe, and the like, can be monitored by a performance feedback system according to one embodiment of the invention. Furthermore, methods, apparatus, and systems according to various embodiments of the invention may be employed in connection with education or entertainment applications, such as interactive video learning tools or games.

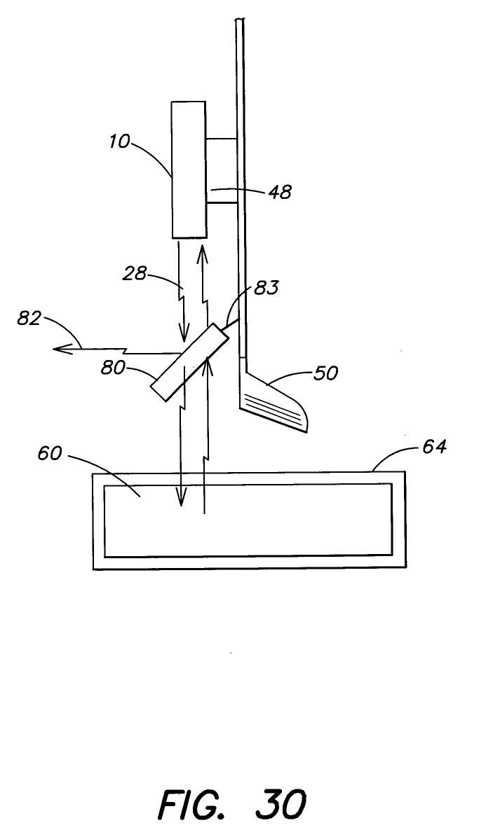

While the foregoing exemplary applications and embodiments of the present invention primarily involve direct radiation paths between a radiation source and at least one reflector, as well as between the at least one reflector and a radiation detector, any number of splitting or redirecting elements may be placed in a radiation path to facilitate other possible applications. For example, FIG. 30 shows the illustration of FIG. 3, further including a splitter 80 placed in the path of radiation 28. For purposes of illustration, the splitter 80 is shown attached to the golf club 50 by splitter attachment 83, but any number of arrangements may be utilized to place a splitting or redirecting element in the path of the radiation. Splitter or redirecting elements suitable for purposes of the invention include, but are not limited to, various reflectors including mirrors and partial reflectors, or polarization sensitive or insensitive cubic beam splitters.

The splitter 80 shown in FIG. 30 allows a portion 82 of the radiation from the source located in apparatus 10 to be “tapped off” without adversely affecting the operation of a performance feedback system according to the invention. The configuration of FIG. 30 allows, for example, a single source radiation beam to impinge on multiple reflectors in different target areas. In a similar manner, a splitter or redirecting element can be placed in the path of radiation reflected from the reflector to allow, for example, a single reflected beam to be detected by multiple detectors in different locations. One or more splitter or redirecting elements in the path of radiation according to various embodiments of the invention may facilitate the determination of motion information, position information, and orientation information of an object such as the golf club 50 as it is swung through a motion path and radiation is detected.

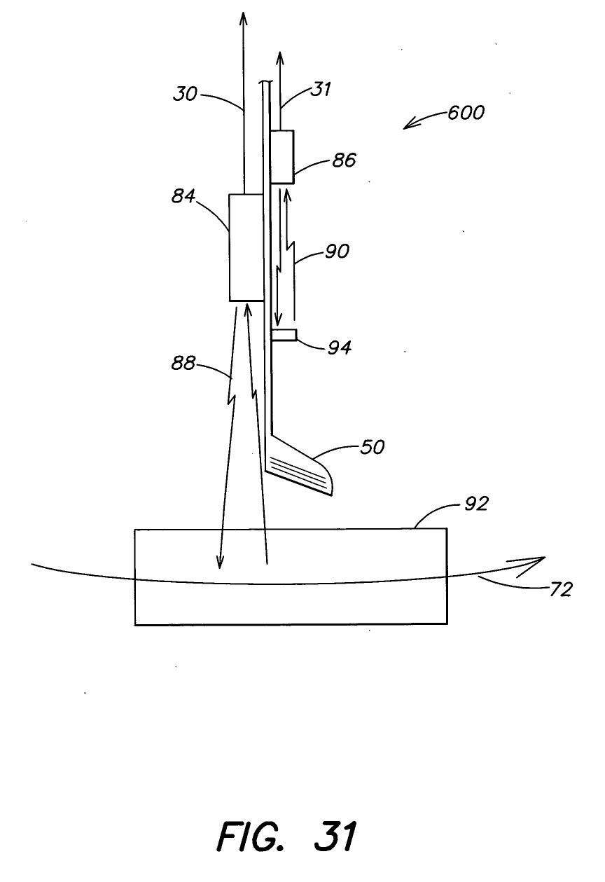

Furthermore, it should be appreciated that more than one apparatus according to is various embodiments of the invention may be integrated with or coupled to a single object to be operated by a subject to perform a movement task. FIG. 31 shows an example of a performance feedback system 600 according to another embodiment of the invention that includes two apparatus 84 and 86 integrated with an object 50, such as a golf club. Each apparatus 84 and 86 may be similar to any of the apparatus described in earlier figures, and generally includes one or more radiation sources, one or more detectors, and one or more indicators. For ease of illustration, each apparatus is shown schematically as a single package including sources, detectors, and indicators. As discussed earlier, however, it should be appreciated that each apparatus may be implemented as discrete components, as a single package, in an “intelligent” accessory or sporting implement, or the respective indicators may be located remotely from the single packages. As shown in FIG. 31, the source of apparatus 84 emits radiation 88, and the source of apparatus 86 emits radiation 90. The radiations 88 and 90 may have the same or different wavelengths and intensities, and may additionally be similarly or differently encoded and/or polarized. Each apparatus 84 and 86 provides behavior control feedback 30 and 31, respectively, to a subject.

In the example system of FIG. 31, a first reflector 92 is placed in an expected swing path 72. Radiation 88 impinges on and is reflected from reflector 92 during some portion of a movement task that successfully tracks or approximates the expected swing path. A second reflector 94 is attached to a shaft of the golf club 50. In the example of FIG. 31, reflector 94 may be sized, shaped, or patterned in such a way as to reflect radiation 90 only for particular flexure amounts of the golf club 50. For example, reflector 94 may be sized so that, at one point during a swing, the club is flexed such that the radiation does not impinge on the reflector 94, and is hence, not reflected back to the apparatus 86.

Such a configuration as illustrated in FIG. 31 may not only provide the subject with information relating to the execution of one or more swings in the form of feedback 30, but may also provide information relating to the appropriateness of a given club for a given golfing situation in the form of feedback 31, and/or provide information relating to an acceleration of the golf club 50 during the movement task. For example, the acceleration of a head of the golf club as the golf club is swung may be observed via a flexure of the golf club. Generally, golfing situations which require slower swings often benefit from clubs having more flexible shafts, which in turn provide greater club face velocity. Likewise, certain skill levels of the subject, or the ability of a subject to swing at very high velocities, may dictate the desirability of a stiffer club shaft. Feedback 31 obtained from apparatus 86 would therefore assist a subject in determining the appropriateness of a given club for a given movement task, based on club flexure, for example.

While FIG. 31 shows an example of an application of the invention employing multiple apparatus, wherein each apparatus operates in conjunction with a respective reflector, one or more apparatus may be used in conjunction with a common reflector if appropriate for a particular application. Furthermore, as described above, each apparatus may emit polarized radiation and/or be used in conjunction with one or more splitting or redirecting elements and one or more reflectors including polarizing filters.

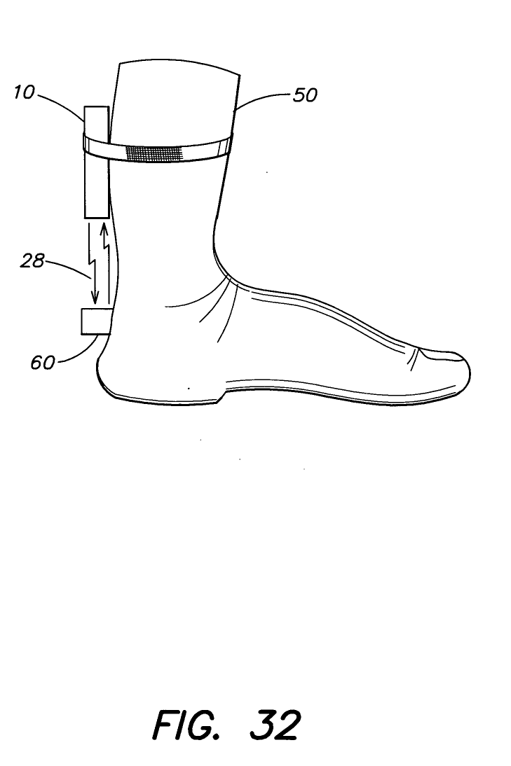

FIG. 32 shows yet another example of a sporting application for a performance feedback system according to one embodiment of the invention. The performance feedback system shown in FIG. 32 is based on the block diagram shown in FIG. 12. In FIG. 32, the apparatus 10 is attached to a leg 50 of a subject, and a reflector 60 is placed in the vicinity of the foot of the subject, for example, on a shoe, sneaker, boot, or the like. Repeated flexures of the subject's leg during a walking or running activity provide a series of radiation detection events and allows the apparatus 10 to derive information related to the speed of the subject's walking or running, which can be used for various training purposes.

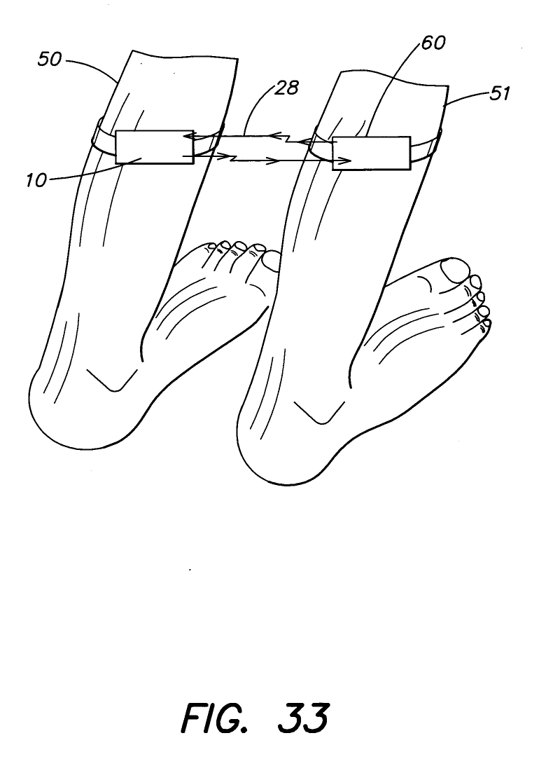

FIG. 33 shows yet another example of a system according to one embodiment of the invention used to measure walking or running speed. In FIG. 33, the apparatus 10 is attached to one leg 50 of a subject and the reflector 60 is attached to another leg 51 of the subject. As the legs 50 and 51 pass each other during the walking or running activity, a series of radiation detection events occurs, from which the apparatus 10 can derive information related to the speed of the subject's walking or running.

From the foregoing, it should be readily appreciated that a wide variety of configurations is facilitated by various embodiments of the invention to provide both instantaneous and aggregate behavior control feedback to a subject in connection with the performance of a task.

Having thus described several illustrative embodiments of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. An apparatus comprising:
at least one radiation source to emit radiation;
at least one radiation detector to detect the radiation; and
at least one indicator coupled to at least one radiation detector to provide behavior control feedback to a subject based on the detected radiation.

2. The apparatus of claim 1, wherein at least one radiation source includes at least one laser.

3. The apparatus of claim 1, wherein at least one radiation detector includes at least one photoelectric detector.

4. The apparatus of claim 1, wherein:
the apparatus includes at least two radiation detectors; and
the apparatus further includes at least two radiation polarizers, each radiation polarizer of the at least two radiation polarizers being disposed in front of a different radiation detector of the at least two radiation detectors such that radiation incident to the apparatus passes through each radiation polarizer before the radiation impinges on the detectors, each radiation polarizer having a different polarization orientation.

5. The apparatus of claim 4, wherein:
a first radiation polarizer of the at least two radiation polarizers has a first polarization orientation;
a second radiation polarizer of the at least two radiation polarizers has a second polarization orientation; and
the first polarization orientation is orthogonal to the second polarization orientation.

6. The apparatus of claim 4, wherein the radiation emitted from the apparatus is polarized radiation.

7. The apparatus of claim 6, wherein the polarized radiation is linearly polarized radiation.

8. The apparatus of claim 6, wherein:
the radiation emitted from at least one source is linearly polarized radiation; and
the apparatus further includes at least one quarter wave plate disposed such that the linearly polarized radiation emitted from the at least one source passes through the at least one quarter wave plate to generate circularly polarized radiation.

9. The apparatus of claim 1, further including:
at least one modulator coupled to at least one radiation source to encode at least some of the radiation emitted by the apparatus; and
at least one filter to filter the detected radiation so as to pass only encoded radiation, the at least one filter being at least one of optically and electrically coupled to at least one radiation detector such that at least one indicator provides the behavior control feedback based on detected encoded radiation.

10. The apparatus of claim 9, wherein the at least one modulator encodes at least some of the radiation emitted by the apparatus with a constant frequency.

11. The apparatus of claim 10, wherein:
the at least one filter passes only detected radiation encoded with the constant frequency; and
at least one indicator provides the behavior control feedback based only on the detected radiation encoded with the constant frequency.

12. The apparatus of claim 1, further including at least one impact detector, coupled to at least one indicator, to detect a pressure disturbance, wherein the at least one indicator provides the behavior control feedback based on at least one of the pressure disturbance and the detected radiation.

13. The apparatus of claim 1, further including an implement operated by the subject to perform a movement task, wherein:
at least one radiation source and at least one radiation detector are coupled to the implement; and
the behavior control feedback provided by at least one indicator includes at least one indication of a successful operation of the implement as the subject operates the implement to perform the movement task.

14. The apparatus of claim 13, wherein the behavior control feedback provided by at least one indicator includes at least one instantaneous indication of a successful operation of the implement as the subject operates the implement to perform the movement task.

15. The apparatus of claim 13, wherein:
at least one indicator includes at least one processor to determine a rotation angle of the implement during the movement task based on the detected radiation; and
the behavior control feedback provided by the at least one indicator is based on at least the rotation angle of the implement.

16. The apparatus of claim 15, wherein the at least one indicator provides the behavior control feedback when the rotation angle of the implement is within a predetermined range with respect to a reference orientation.

17. The apparatus of claim 16, wherein the predetermined range is adjustable.

18. The apparatus of claim 15, wherein:
the implement is a sporting implement; and
the behavior control feedback provided by the at least one indicator includes at least one indication of a successful swing of the sporting implement.

19. The apparatus of claim 18, wherein:
the sporting implement is a golf club; and
the rotation angle is a club rotation angle about a first axis through the golf club along a length of a shaft of the golf club.

20. The apparatus of claim 1, wherein at least one indicator includes at least one processor to process at least one detected radiation signal output by at least one radiation detector based on the detected radiation.

21.-137. (canceled)
